(19) United States
(12) Patent Application Publication
(10) Pub. No.: US 2025/0111116 A1
(43) Pub. Date: Apr. 3, 2025

(54) OPTIMIZATION OF HEATERS FOR TUNING PHOTONIC DEVICES

(71) Applicant: X Development LLC, Mountain View, CA (US)

(72) Inventors: Brian Adolf, San Mateo, CA (US); Philip Watson, Felton, CA (US); Yi-Kuei Ryan Wu, San Jose, CA (US); Ian Williamson, Palo Alto, CA (US)

(21) Appl. No.: 18/479,731

(22) Filed: Oct. 2, 2023

(51) Int. Cl. G06F 30/337; G06F 30/3312; G06F 113/18; G06F 119/06; G06F 119/08; G06F 119/12

(52) U.S. Cl. CPC G06F 30/337; G06F 30/3312; G06F 2113/18; G06F 2119/06; G06F 2119/08; G06F 2119/12

(57) ABSTRACT

In some embodiments, a computer-implemented method of creating a design for an optoelectronic device is provided. A computing system determines an initial heater design that includes one or more heater parameters. The computing system determines a temperature gradation by simulating performance of the initial heater design in adjusting an environmental temperature to a nominal temperature. The computing system simulates performance of a nominal optimized design of a dispersive region of the optoelectronic device, given the temperature gradation, to determine a temperature-influenced performance loss value. The computing system determines a heater parameter gradient based on the temperature-influenced performance loss value, and revises the heater parameters based at least in part on the heater parameter gradient to create a revised heater design.

### TECHNICAL FIELD

This disclosure relates generally to photonic devices, and in particular but not exclusively, relates to photonic devices that include heaters.

### BACKGROUND

Fiber-optic communication is typically employed to transmit information from one place to another via light that has been modulated to carry the information. For example, many telecommunication companies use optical fiber to transmit telephone signals, internet communication, and cable television signals. Optoelectronic devices, including but not limited to multiplexers, demultiplexers, waveguide bends, detectors, and modulators, may be used to transmit, receive, and process information transmitted via light.

### BRIEF SUMMARY

In some embodiments, a non-transitory computer-readable medium having computer-executable instructions stored thereon is provided. The instructions, in response to execution by one or more processors of a computing system, cause the computing system to perform actions for creating a design for an optoelectronic device, the actions comprising: determining, by the computing system, an initial heater design that includes one or more heater parameters; determining, by the computing system, a temperature gradation by simulating performance of the initial heater design in adjusting an environmental temperature to a nominal temperature; simulating, by the computing system, performance of a nominal optimized design of a dispersive region of the optoelectronic device, given the temperature gradation, to determine a temperature-influenced performance loss value; determining, by the computing system, a heater parameter gradient based on the temperature-influenced performance loss value; and revising the heater parameters based at least in part on the heater parameter gradient to create a revised heater design.

In some embodiments, a computer-implemented method of creating a design for an optoelectronic device is provided. A computing system determines an initial heater design that includes one or more heater parameters. The computing system determines a temperature gradation by simulating performance of the initial heater design in adjusting an environmental temperature to a nominal temperature. The computing system simulates performance of a nominal optimized design of a dispersive region of the optoelectronic device, given the temperature gradation, to determine a temperature-influenced performance loss value. The computing system determines a heater parameter gradient based on the temperature-influenced performance loss value, and revises the heater parameters based at least in part on the heater parameter gradient to create a revised heater design.

### BRIEF DESCRIPTION OF THE SEVERAL VIEWS OF THE DRAWINGS

Non-limiting and non-exhaustive embodiments of the disclosure are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a functional block diagram illustrating a non-limiting example embodiment of a system for optical communication between two optical communication devices via an optical signal, according to various aspects of the present disclosure.

FIG. 2A and FIG. 2B respectively illustrate a non-limiting example embodiment of a demultiplexer and multiplexer, according to various aspects of the present disclosure.

FIG. 2C illustrates a non-limiting example embodiment of a distinct wavelength channel of a multi-channel optical signal, according to various aspects of the present disclosure.

FIG. 3A-FIG. 3D illustrate different views of a non-limiting example embodiment of a photonic demultiplexer, according to various aspects of the present disclosure.

FIG. 4A and FIG. 4B illustrate a more detailed cross-sectional view of a dispersive region of a non-limiting example embodiment of a photonic demultiplexer, according to various aspects of the present disclosure.

FIG. 5 is a functional block diagram illustrating a non-limiting example embodiment of a system for generating a design of a photonic integrated circuit, according to various aspects of the present disclosure.

FIG. 6A illustrates a non-limiting example embodiment of a simulated environment describing a photonic integrated circuit, according to various aspects of the present disclosure.

FIG. 6B illustrates a non-limiting example embodiment of an operational simulation of a photonic integrated circuit, according to various aspects of the present disclosure.

FIG. 6C illustrates a non-limiting example embodiment of an adjoint simulation within the simulated environment by backpropagating a loss value, according to various aspects of the present disclosure.

FIG. 7A is a flow chart illustrating example time steps for an operational simulation and an adjoint simulation, in accordance with various aspects of the present disclosure.

FIG. 7B is a chart illustrating the relationship between the update operation for the operational simulation and the adjoint simulation (e.g., backpropagation), in accordance with an embodiment of the present disclosure.

FIG. 8 is a flowchart that illustrates a non-limiting example embodiment of a method for generating a design of physical device such as a photonic integrated circuit, in accordance with various aspects of the present disclosure.

FIG. 9 is a vertical schematic of a stack of layers in an optoelectronic device that includes a heater according to various aspects of the present disclosure.

FIG. 10A and FIG. 10B are schematic illustrations that show two non-limiting examples of designs for heating elements that have been generated by or may be adjusted using inverse design techniques according to various aspects of the present disclosure.

FIG. 11A-FIG. 11B are a flowchart that illustrates a non-limiting example embodiment of optimizing a design for a heater for an optoelectronic device according to various aspects of the present disclosure.

### DETAILED DESCRIPTION

Embodiments of techniques for inverse design of physical devices are described herein, in the context of generating designs for optoelectronic devices that incorporate heaters that are also generated using inverse design. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Wavelength division multiplexing and its variants (e.g., dense wavelength division multiplexing, coarse wavelength division multiplexing, and the like) take advantage of the bandwidth of optical fibers by bundling multiple optical carrier signals onto a single optical fiber. Once the multiple carrier signals are bundled together, they are transmitted from one place to another over the single optical fiber where they may be demultiplexed to be read out by an optical communication device. However, devices that decouple the carrier signals from one another remain prohibitive in terms of cost, size, and the like.

Moreover, design of photonic devices, such as those used for optical communication, are traditionally designed via conventional techniques sometimes determined through a simple guess and check method or manually-guided grid-search in which a small number of design parameters from pre-determined designs or building blocks are adjusted for suitability to a particular application. However, in actuality, these devices may have design parameters ranging from hundreds all the way to many billions or more, dependent on the device size and functionality. Thus, as functionality of photonic devices increases and manufacturing tolerances improve to allow for smaller device feature sizes, it becomes increasingly important to take full advantage of these improvements via optimized device design.

Described herein are embodiments of optoelectronic devices (e.g., a multi-channel photonic demultiplexer and/or multiplexer) having a design obtainable by an inverse design process, including an inverse-designed heater. More specifically, techniques described in embodiments herein utilize gradient-based optimization in combination with first-principle simulations to generate a design from an understanding of the underlying physics that are expected to govern the operation of the optoelectronic device and the heater. It is appreciated in other embodiments, design optimization of photonic integrated circuits without gradient-based techniques may also be used. Advantageously, embodiments and techniques described herein are not limited to conventional techniques used for design of photonic devices, in which a small number of design parameters for pre-determined building blocks are adjusted based on suitability to a particular application. Rather, the first-principles based designs described herein are not necessarily dependent on human intuition and generally may result in designs which outstrip current state-of-the-art designs in performance, size, robustness, or a combination thereof. Further still, rather than being limited to a small number of design parameters due to conventional techniques, the embodiments and techniques described herein may provide scalable optimization of a nearly unlimited number of design parameters. It will also be appreciated that, though the design and fabrication of photonic integrated circuits is described throughout the present text, similar inverse design techniques may be used to generate designs for other types of physical devices.

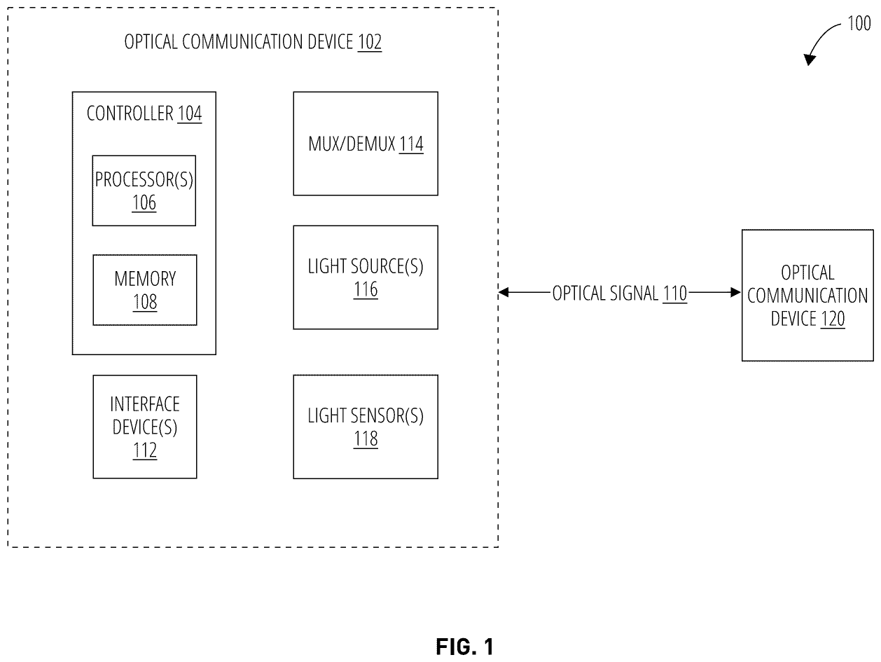

FIG. 1 is a functional block diagram illustrating a system 100 for optical communication (e.g., via wavelength division multiplexing or other techniques) between optical communication device 102 and optical communication device 120 via optical signal 110, in accordance with various aspects of the present disclosure. More generally, optical communication device 102 is configured to transmit information by modulating light from one or more light sources into a multi-channel optical signal 110 (e.g., a singular optical signal that includes a plurality of distinct wavelength channels) that is subsequently transmitted from optical communication device 102 to optical communication device 120 via an optical fiber, a light guide, a wave guide, or other photonic device. Optical communication device 120 receives the multi-channel optical signal 110 and demultiplexes each of the plurality of distinct wavelength channels from the multi-channel optical signal 110 to extract the transmitted information. It is appreciated that in some embodiments optical communication device 102 and optical communication device 120 may be distinct and separate devices (e.g., an optical transceiver or transmitter communicatively coupled via one or more optical fibers to a separate optical transceiver or receiver). However, in other embodiments, optical communication device 102 and optical communication device 120 may be part of a singular component or device (e.g., a smartphone, a tablet, a computer, optical device, or the like). For example, optical communication device 102 and optical communication device 120 may both be constituent components on a monolithic integrated circuit that are coupled to one another via a waveguide that is embedded within the monolithic integrated circuit and is adapted to carry optical signal 110 between optical communication device 102 and optical communication device 120 or otherwise transmit the optical signal between one place and another.

In the illustrated embodiment, optical communication device 102 includes a controller 104, one or more interface device(s) 112 (e.g., fiber optic couplers, light guides, waveguides, and the like), a multiplexer (mux), demultiplexer (demux), or combination thereof (MUX/DEMUX 114), one or more light source(s) 116 (e.g., light emitting diodes, lasers, and the like), and one or more light sensor(s) 118 (e.g., photodiodes, phototransistors, photoresistors, and the like) coupled to one another. The controller includes one or more processor(s) 106 (e.g., one or more central processing units, application specific circuits, field programmable gate arrays, or otherwise) and memory 108 (e.g., volatile memory such as DRAM and SAM, non-volatile memory such as ROM, flash memory, and the like). It is appreciated that optical communication device 120 may include the same or similar elements as optical communication device 102, which have been omitted for clarity.

Controller 104 orchestrates operation of optical communication device 102 for transmitting and/or receiving optical signal 110 (e.g., a multi-channel optical signal having a plurality of distinct wavelength channels or otherwise). Controller 104 includes software (e.g., instructions included in memory 108 coupled to processor 106) and/or hardware logic (e.g., application specific integrated circuits, field-programmable gate arrays, and the like) that when executed by controller 104 causes controller 104 and/or optical communication device 102 to perform operations.

In one embodiment, controller 104 may choreograph operations of optical communication device 102 to cause light source(s) 116 to generate a plurality of distinct wavelength channels that are multiplexed via MUX/DEMUX 114 into a multi-channel optical signal 110 that is subsequently transmitted to optical communication device 120 via interface device 112. In other words, light source(s) 116 may output light having different wavelengths (e.g., 1271 nm, 1291 nm, 1311 nm, 1331 nm, 1506 nm, 1514 nm, 1551 nm, 1571, or otherwise) that may be modulated or pulsed via controller 104 to generate a plurality of distinct wavelength channels representative of information. The plurality of distinct wavelength channels are subsequently combined or otherwise multiplexed via MUX/DEMUX 114 into a multi-channel optical signal 110 that is transmitted to optical communication device 120 via interface device 112. In the same or another embodiment, controller 104 may choreograph operations of optical communication device 102 to cause a plurality of distinct wavelength channels to be demultiplexed via MUX/DEMUX 114 from a multi-channel optical signal 110 that is received via interface device 112 from optical communication device 120.

It is appreciated that in some embodiments certain elements of optical communication device 102 and/or optical communication device 120 may have been omitted to avoid obscuring certain aspects of the disclosure. For example, optical communication device 102 and optical communication device 120 may include amplification circuitry, lenses, or components to facilitate transmitting and receiving optical signal 110. It is further appreciated that in some embodiments optical communication device 102 and/or optical communication device 120 may not necessarily include all elements illustrated in FIG. 1. For example, in one embodiment optical communication device 102 and/or optical communication device 120 are passive devices that operate as an intermediary device that may passively multiplex a plurality of distinct wavelength channels into a multi-channel optical signal 110 and/or demultiplex a plurality of distinct wavelength channels from a multi-channel optical signal 110.

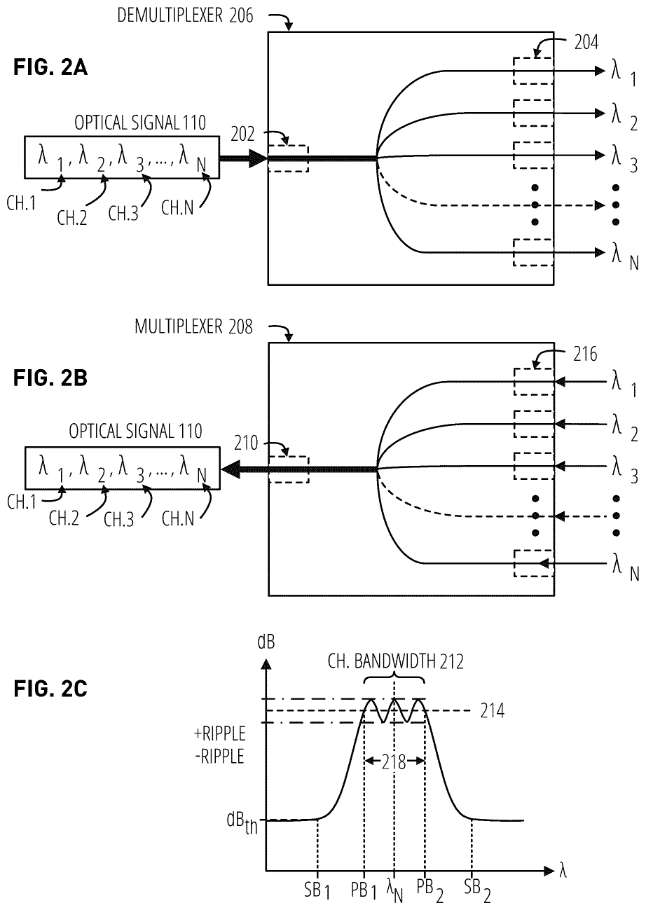

FIG. 2A and FIG. 2A respectively illustrate an example demultiplexer 206 and multiplexer 208, in accordance with various aspects of the present disclosure. Demultiplexer 206 and multiplexer 208 are possible embodiments of MUX/DEMUX 114 illustrated in FIG. 1, and which may be part of an optoelectronic device such as an integrated photonic circuit, silicon photonic device, or otherwise

As illustrated in FIG. 2A, demultiplexer 206 includes an input region 202 and a plurality of output regions 204. Demultiplexer 206 is configured to receive a multi-channel optical signal 110 that includes a plurality of distinct wavelength channels (e.g., Ch. 1, Ch. 2, Ch. 3, . . . . Ch. N, each having a center wavelength respectively corresponding to λ₁, λ₂, λ₃, . . . λ_{N}) via input region 202 (e.g., a waveguide that may correspond to interface device 112 illustrated in FIG. 1) to optically separate each of the plurality of distinct wavelength channels from the multi-channel optical signal 110 and respectively guide each of the plurality of distinct wavelength channels to a corresponding one of a plurality of output regions 204 (e.g., a plurality of waveguides that may correspond to interface device(s) 112 illustrated in FIG. 1). More specifically, in the illustrated embodiment, each of the output regions 204 receives a portion of the multi-channel optical signal that corresponds to, or is otherwise representative of, one of the plurality of distinct wavelength channels that may be output as plurality of optical signals (e.g., λ₁, λ₂, λ₃, . . . λ_{N}). The plurality of output regions 204 may each be coupled to a respective light sensor (e.g., corresponding to light sensor(s) 118 illustrated in FIG. 1), which may be utilized to convert the optical signals demultiplexed from the multi-channel optical signal 110 into electrical signals for further processing.

In the illustrated embodiment of FIG. 2B, multiplexer 208 includes a plurality of input regions 216 and an output region 210. Multiplexer 208 is configured to receive a plurality of distinct optical signals (e.g., λ₁, λ₂, λ₃, . . . λ_{N}), each at a respective one of the plurality of input regions 216 (e.g., a plurality of waveguides that may correspond to interface device(s) 112 illustrated in FIG. 1). Multiplexer 208 is structured or otherwise configured to optically combine (i.e., multiplex) each of the plurality of distinct wavelength channels into a multi-channel optical signal 110 that is guided to output region 210 (e.g., a waveguide that may correspond to interface device 112 illustrated in FIG. 1). It is appreciated that in some embodiments, demultiplexer 206 illustrated in FIG. 2A and multiplexer 208 illustrated in FIG. 2B may be bidirectional such that each device may function as both a demultiplexer and multiplexer.

FIG. 2C illustrates an example distinct wavelength channel of a multi-channel optical signal (e.g., Ch. N is multi-channel optical signal 110 illustrated in FIG. 1, FIG. 2A, and FIG. 2B), in accordance with various aspects of the present disclosure. The example channel may be representative of an individual channel included in a plurality of distinct wavelength channels of the multi-channel optical signal that may be demultiplexed and/or multiplexed by demultiplexer 206 of FIG. 2A and/or multiplexer 208 of FIG. 2B. Each of the distinct wavelength channels may have different center wavelengths (AN) including at least one of 1271 nm, 1291 nm, 1311 nm, 1331 nm, 1506 nm, 1514 nm, 1551 nm, or 1571 nm, or otherwise. In the illustrated embodiment of FIG. 2C, the distinct wavelength channel has a channel bandwidth 212 of approximately 13 nm wide. However, in other embodiments the channel bandwidth may be different than 13 nm wide. Rather, the channel bandwidth may be considered a configurable parameter that is dependent upon the structure of MUX/DEMUX 114 of FIG. 1, demultiplexer 206 of FIG. 2A, and/or multiplexer 208 of FIG. 2B. For example, in some embodiments each of the plurality of distinct wavelength channels may share a common bandwidth that may correspond to 13 nm or otherwise. Referring back to FIG. 2C, the channel bandwidth 212 may be defined as the width of a passband region 218 (i.e., the region defined as being between PB₁ and PB₂). The passband region 218 may represent an approximate power transmission of a demultiplexer or multiplexer. It is appreciated that in some embodiments the passband region 218 may include ripple as illustrated in FIG. 2C, which corresponds to fluctuations within the passband region 218. In one or more embodiments, the ripple within the passband region around a central value 214 may be +/−2 dB or less, +/−1 dB or less, +/−0.5 dB or less, or otherwise. In some embodiments, the channel bandwidth 212 may be defined by the passband region 218. In other embodiments, the channel bandwidth 212 may be defined as the measured power above a threshold (e.g., dBₜₕ). For example, demultiplexer 206 illustrated in FIG. 2A may optically separate channel N from multi-channel optical signal 110 and have a corresponding channel bandwidth for channel N equivalent to the range of wavelengths above a threshold value that are transmitted to the output region 204 mapped to channel N (i.e., λ_{N}). In the same or other embodiments, isolation of the channel (i.e., defined by channel bandwidth 212) may also be considered when optimizing the design. The isolation may be defined as a ratio between the passband region 218 and the stopband regions (e.g., regions less than SB₁ and greater than SB₂). It is further appreciated that transition band regions (e.g., a first transition region between SB₁ and PB₁ and a second transition region between PB₂ and SB₂) are exemplary and may be exaggerated for the purposes of illustration. In some embodiments, optimization of the design of the photonic demultiplexer may also include a target metric for a slope, width, or the like of the transition band regions.

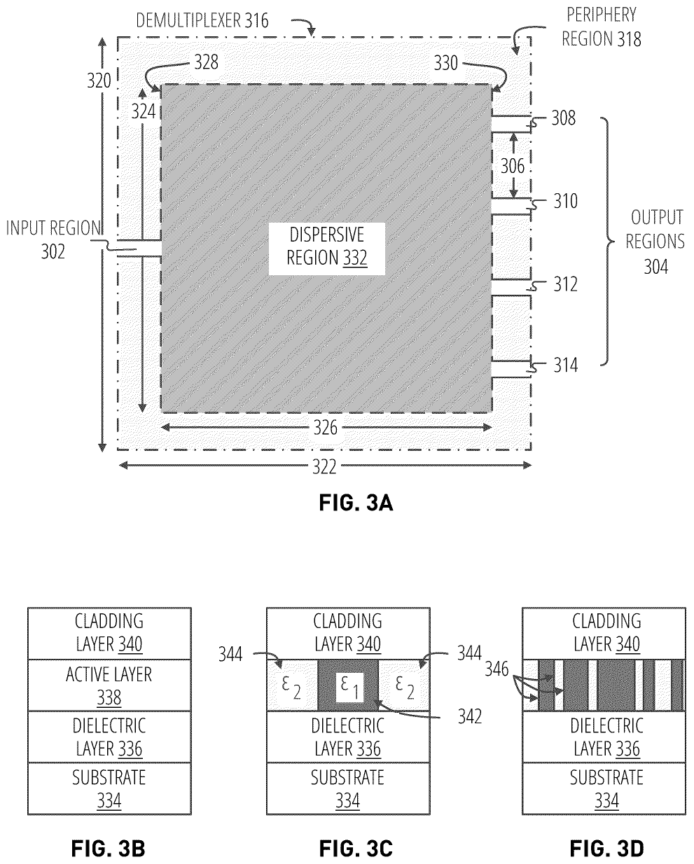

FIG. 3A-FIG. 3D illustrate different views of an example photonic demultiplexer, in accordance with an embodiment of the present disclosure. Photonic demultiplexer 316 is one possible implementation of MUX/DEMUX 114 illustrated in FIG. 1 and demultiplexer 206 illustrated in FIG. 2A. It is further appreciated that while discussion henceforth may be directed towards photonic integrated circuits capable of demultiplexing a plurality of distinct wavelength channels from a multi-channel optical signal, that in other embodiments, an optoelectronic device designed using techniques disclosed herein may also or alternatively be capable of multiplexing a plurality of distinct wavelength channels into a multi-channel optical signal, or other types of optoelectronic devices may provide other types of optical processing, in accordance with embodiments of the present disclosure.

FIG. 3A illustrates a cross-sectional view of demultiplexer 316 along a lateral plane within an active layer defined by a width 320 and a length 322 of the demultiplexer 316. As illustrated, demultiplexer 316 includes an input region 302 (e.g., comparable to input region 202 illustrated in FIG. 2A), a plurality of output regions 304 (e.g., comparable to plurality of output regions 204 illustrated in FIG. 2A), and a dispersive region optically disposed between the input region 302 and plurality of output regions 304. The input region 302 and plurality of output regions 304 (e.g., output region 308, output region 310, output region 312, and output region 314) may each be waveguides (e.g., slab waveguide, strip waveguide, slot waveguide, or the like) capable of propagating light along the path of the waveguide. The dispersive region 332 includes a first material and a second material (see, e.g., FIG. 3D) inhomogeneously interspersed to form a plurality of interfaces that each correspond to a change in refractive index of the dispersive region 332 and collectively structure the dispersive region 332 to optically separate each of a plurality of distinct wavelength channels (e.g., Ch. 1, Ch. 2, Ch. 3, . . . . Ch. N illustrated in FIG. 2A) from a multi-channel optical signal (e.g., optical signal 110 illustrated in FIG. 2A) and respectively guide each of the plurality of distinct wavelength channels to a corresponding one of the plurality of output regions 304 when the input region 302 receives the multi-channel optical signal. In other words, input region 302 is adapted to receive the multi-channel optical signal including a plurality of distinct wavelength channels and the plurality of output regions 304 are adapted to each receive a corresponding one of the plurality of distinct wavelength channels demultiplexed from the multi-channel optical signal via dispersive region 332.

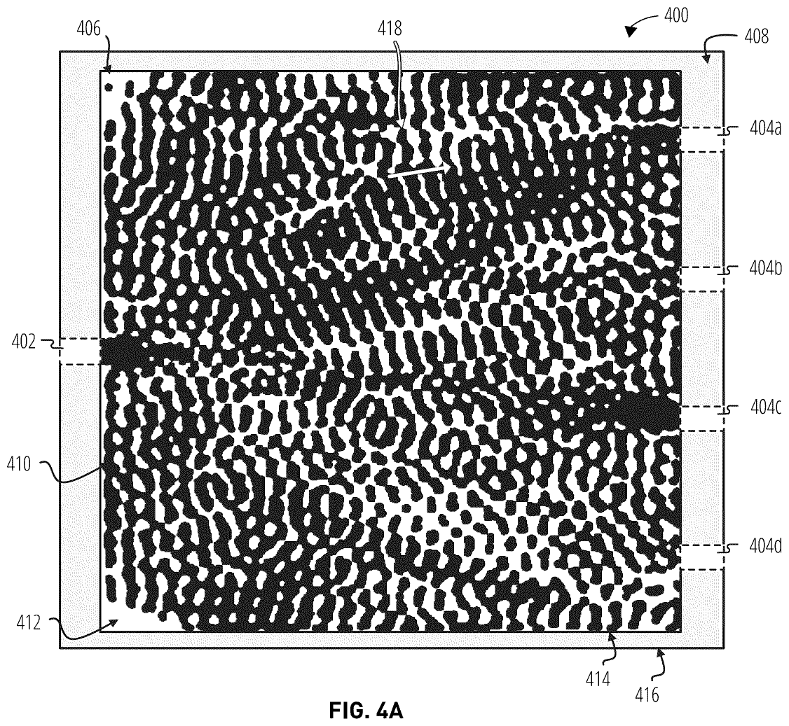

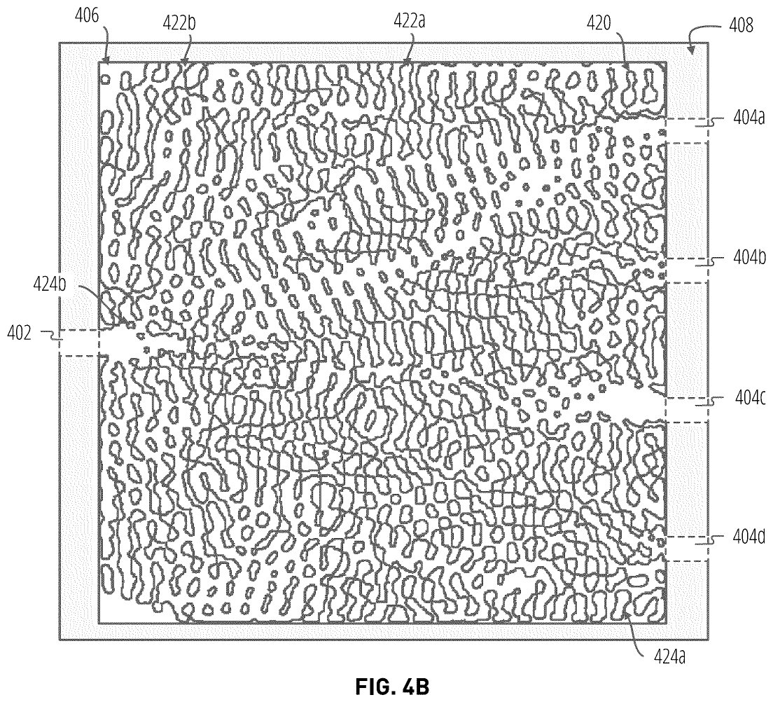

As illustrated in FIG. 3A, and more clearly shown in FIG. 3D and FIG. 4A-FIG. 4B, the shape and arrangement of the first and second material that are inhomogeneously interspersed create a plurality of interfaces that collectively form a material interface pattern along a cross-sectional area of dispersive region 332 that is at least partially surrounded by a periphery region 318 that includes the second material. In some embodiments periphery region 318 has a substantially homogeneous composition that includes the second material. In the illustrated embodiment, dispersive region 332 includes a first side 328 and a second side 330 that each interface with an inner boundary (i.e., the unlabeled dashed line of periphery region 318 disposed between dispersive region 332 and dashed-dotted line corresponding to an outer boundary of periphery region 318). First side 328 and second side 330 are disposed correspond to opposing sides of dispersive region 332. Input region 302 is disposed proximate to first side 328 (e.g., one side of input region 302 abuts first side 328 of dispersive region 332) while each of the plurality of output regions 304 are disposed proximate to second side 330 (e.g., one side of each of the plurality of output regions 304 abuts second side 330 of dispersive region 332).

In the illustrated embodiment each of the plurality of output regions 304 are parallel to each other one of the plurality of output regions 304. However, in other embodiments the plurality of output regions 304 may not be parallel to one another or even disposed on the same side (e.g., one or more of the plurality of output regions 304 and/or input region 302 may be disposed proximate to sides of dispersive region 332 that are adjacent to first side 328 and/or second side 330). In some embodiments adjacent ones of the plurality of output regions are separated from each other by a common separation distance when the plurality of output regions includes at least three output regions. For example, as illustrated adjacent output region 308 and output region 310 are separated from one another by distance 306, which may be common to the separation distance between other pairs of adjacent output regions.

As illustrated in the embodiment of FIG. 3A, demultiplexer 316 includes four output regions 304 (e.g., output region 308, output region 310, output region 312, output region 314) that are each respectively mapped (i.e., by virtue of the structure of dispersive region 332) to a respective one of four channels included in a plurality of distinct wavelength channels. More specifically, the plurality of interfaces of dispersive region 332, defined by the inhomogeneous interspersion of a first material and a second material, form a material interface pattern along a cross-sectional area of the dispersive region 332 (e.g., as illustrated in FIG. 3A, FIG. 4A, or FIG. 4B) to cause the dispersive region 332 to optically separate each of the four channels from the multi-channel optical signal and route each of the four channels to a respective one of the four output regions 304 when the input region 302 regions the multi-channel optical signal.

It is noted that the first material and second material of dispersive region 332 are arranged and shaped within the dispersive region such that the material interface pattern is substantially proportional to a design obtainable with an inverse design process, which will be discussed in greater detail later in the present disclosure. More specifically, in some embodiments, the inverse design process may include iterative gradient-based optimization of a design based at least in part on a loss function that incorporates a performance loss (e.g., to enforce functionality) and a fabrication loss (e.g., to enforce fabricability and binarization of a first material and a second material) that is reduced or otherwise adjusted via iterative gradient-based optimization to generate the design. In the same or other embodiments, other optimization techniques may be used instead of, or jointly with, gradient-based optimization. Advantageously, this allows for optimization of a near unlimited number of design parameters to achieve functionality and performance within a predetermined area that may not have been possible with conventional design techniques.

For example, in one embodiment, dispersive region 332 is structured to optically separate each of the four channels from the multi-channel optical signal within a predetermined area of 35 μm×35 μm (e.g., as defined by width 324 and length 326 of dispersive region 332) when the input region 302 receives the multi-channel optical signal. In the same or another embodiment, the dispersive region is structured to accommodate a common bandwidth for each of the four channels, each of the four channels having different center wavelengths. In one embodiment the common bandwidth is approximately 13 nm wide and the different center wavelengths is selected from a group consisting of 1271 nm, 1291 nm, 1311 nm, 1331 nm, 1506 nm, 1514 nm, 1551 nm, and 1571 nm. In some embodiments, the entire structure of demultiplexer 316 (e.g., including input region 302, periphery region 318, dispersive region 332, and plurality of output regions 304) fits within a predetermined area (e.g., as defined by width 320 and length 322). In one embodiment the predetermined area is 35 μm×35 μm. It is appreciated that in other embodiments dispersive region 332 and/or demultiplexer 316 fits within other areas greater than or less than 35 μm×35 μm, which may result in changes to the structure of dispersive region 332 (e.g., the arrangement and shape of the first and second material) and/or other components of demultiplexer 316.

In the same or other embodiments the dispersive region is structured to have a power transmission of −2 dB or greater from the input region 302, through the dispersive region 332, and to the corresponding one of the plurality of output regions 304 for a given wavelength within one of the plurality of distinct wavelength channels. For example, if channel 1 of a multi-channel optical signal is mapped to output region 308, then when demultiplexer 316 receives the multi-channel optical signal at input region 302 the dispersive region 332 will optically separate channel 1 from the multi-channel optical signal and guide a portion of the multi-channel optical signal corresponding to channel 1 to output region 308 with a power transmission of −2 dB or greater. In the same or another embodiment, dispersive region 332 is structured such that an adverse power transmission (i.e., isolation) for the given wavelength from the input region to any of the plurality of output regions other than the corresponding one of the plurality of output regions is −30 dB or less, −22 dB or less, or otherwise. For example, if channel 1 of a multi-channel optical signal is mapped to output region 308, then the adverse power transmission from input region 302 to any other one of the plurality of output regions (e.g., output region 310, output region 312, output region 314) other than the corresponding one of the plurality of output regions (e.g., output region 308) is −30 dB or less, −22 dB or less, or otherwise. In some embodiments, a maximum power reflection from demultiplexer 316 of an input signal (e.g., a multi-channel optical signal) received at an input region (e.g., input region 302) is reflected back to the input region by dispersive region 332 or otherwise is −40 dB or less, −20 dB or less, −8 dB or less, or otherwise. It is appreciated that in other embodiments the power transmission, adverse power transmission, maximum power, or other performance characteristics may be different than the respective values discussed herein, but the structure of dispersive region 332 may change due to the intrinsic relationship between structure, functionality, and performance of demultiplexer 316.

FIG. 3B illustrates a vertical schematic or stack of various layers that are included in the illustrated embodiment of demultiplexer 316. However, it is appreciated that the illustrated embodiment is not exhaustive and that certain features or elements may be omitted to avoid obscuring certain aspects of the disclosure. In the illustrated embodiment, demultiplexer 316 includes substrate 334, dielectric layer 336, active layer 338 (e.g., as shown in the cross-sectional illustration of FIG. 3A), and a cladding layer 340. In some embodiments, demultiplexer 316 may be, in part or otherwise, a photonic integrated circuit or silicon photonic device that is compatible with conventional fabrication techniques (e.g., lithographic techniques such as photolithographic, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 334, a silicon dioxide dielectric layer that corresponds to dielectric layer 336, a silicon layer (e.g., intrinsic, doped, or otherwise), and a oxide layer (e.g., intrinsic, grown, or otherwise). In one embodiment, the silicon in the active layer 338 may be etched selectively by lithographically creating a pattern on the SOI wafer that is transferred to SOI wafer via a dry etch process (e.g., via a photoresist mask or other hard mask) to remove portions of the silicon. The silicon may be etched all the way down to dielectric layer 336 to form voids that may subsequently be backfilled with silicon dioxide that is subsequently encapsulated with silicon dioxide to form cladding layer 340. In one embodiment, there may be several etch depths including a full etch depth of the silicon to obtain the targeted structure. In one embodiment, the silicon may be 206 nm thick and thus the full etch depth may be 206 nm. In some embodiments, this may be a two-step encapsulation process in which two silicon dioxide depositions are performed with an intermediate chemical mechanical planarization used to yield a planar surface.

FIG. 3C illustrates a more detailed view of active layer 338 (relative to FIG. 3B) taken along a portion of periphery region 318 that includes input region 302 of FIG. 3A. In the illustrated embodiment, active layer 338 includes a first material 342 with a refractive index of 81 and a second material 344 with a refractive index of 22 that is different from 81. Homogenous regions of the first material 342 and the second material 344 may form waveguides or portions of waveguides that correspond to input region 302 and plurality of output regions 304 as illustrated in FIG. 3A and FIG. 3C.

FIG. 3D illustrates a more detailed view of active layer 338 (relative to FIG. 3B) taken along dispersive region 332. As described previously, active layer 338 includes a first material 342 (e.g., silicon) and a second material 344 (e.g., silicon dioxide) that are inhomogeneously interspersed to form a plurality of interfaces 346 that collectively form a material interface pattern. Each of the plurality of interfaces 346 that form the interface pattern correspond to a change in refractive index of dispersive region 332 to structure the dispersive region (i.e., the shape and arrangement of first material 342 and second material 344) to provide, at least in part, the functionality of demultiplexer 316 (i.e., optical separation of the plurality of distinct wavelength channels from the multi-channel optical signal and respective guidance of each of the plurality of distinct wavelength channels to the corresponding one of the plurality of output regions 304 when the input region 302 receives the multi-channel optical signal).

It is appreciated that in the illustrated embodiments of demultiplexer 316 as shown in FIG. 3A-FIG. 3D, the change in refractive index is shown as being vertically consistent (i.e., the first material 342 and second material 344 form interfaces that are substantially vertical or perpendicular to a lateral plane or cross-section of demultiplexer 316. However, in the same or other embodiments, the plurality of interfaces (e.g., interfaces 346 illustrated in FIG. 3D) may not be substantially perpendicular with the lateral plane or cross-section of demultiplexer 316.

FIG. 4A illustrates a more detailed cross-sectional view of a dispersive region of example photonic demultiplexer 400, in accordance with an embodiment of the present disclosure. FIG. 4B illustrates a more detailed view of an interface pattern formed by the shape and arrangement of a first material 410 and a second material 412 for the dispersive region of the photonic demultiplexer 400 of FIG. 4A. Photonic demultiplexer 400 is one possible implementation of MUX/DEMUX 114 illustrated in FIG. 1, demultiplexer 206 illustrated in FIG. 2A, and demultiplexer 316 illustrated in FIG. 3A-FIG. 3D.

As illustrated in FIG. 4A and FIG. 4B, photonic demultiplexer 400 includes an input region 402, a plurality of output regions 404a-404d, and a dispersive region 406 optically disposed between input region 402 and plurality of output regions 404a-404d. Dispersive region 406 is surrounded, at least in part, by a peripheral region 408 that includes an inner boundary 414 and an outer boundary 416. It is appreciated that like named or labeled elements of photonic demultiplexer 400 may similarly correspond to like named or labeled elements of other demultiplexers described in embodiments of the present disclosure.

The first material 410 (i.e., black colored regions within dispersive region 406) and second material 412 (i.e., white colored regions within dispersive region 406) of photonic demultiplexer 400 are inhomogeneously interspersed to create a plurality of interfaces that collectively form material interface pattern 420 as illustrated in FIG. 4B. More specifically, an inverse design process that utilizes iterative gradient-based optimization, Markov Chain Monte Carlo optimization, or other optimization techniques combined with first principles simulations to generate a design that is substantially replicated by dispersive region 406 within a proportional or scaled manner such that photonic demultiplexer 400 provides the desired functionality. In the illustrated embodiment, dispersive region 406 is structured to optically separate each of a plurality of distinct wavelength channels from a multi-channel optical signal and respectively guide each of the plurality of distinct wavelength channels to a corresponding one of the plurality of output regions 404a-404d when the input region 402 receives the multi-channel optical signal. More specifically, the plurality of output regions 404a-404d are respectively mapped to wavelength channels having center wavelengths correspond to 1271 nm, 1291 nm, 1311 nm, and 1331 nm. In another embodiment, output regions 404a-404d are respectfully mapped to wavelength channels having center wavelengths that correspond to 1506 nm, 1514 nm, 1551 nm, and 1571 nm.

As illustrated in FIG. 4B, material interface pattern 420, which is defined by the black lines within dispersive region 406 and corresponds to a change in refractive index within dispersive region 406, includes a plurality of protrusions 422a-422b. A first protrusion 422a is formed of the first material 410 and extends from peripheral region 408 into dispersive region 406. Similarly, a second protrusion 422b is formed of the second material 412 and extends from peripheral region 408 into dispersive region 406. Further illustrated in FIG. 4B, dispersive region 406 includes a plurality of islands 424a-424b formed of either the first material 410 or the second material 412. The plurality of islands 424a-424b include a first island 424a that is formed of the first material 410 and is surrounded by the second material 412. The plurality of islands 424a-424b also includes a second island 424b that is formed of the second material 412 and is surrounded by the first material 410.

In some embodiments, material interface pattern 420 includes one or more dendritic shapes, wherein each of the one or more dendritic shapes are defined as a branched structure formed from first material 410 or second material 412 and having a width that alternates between increasing and decreasing in size along a corresponding direction. Referring back to FIG. 4A, for clarity, dendritic structure 418 is labeled with a white arrow having a black border. As can be seen, the width of dendritic structure 418 alternatively increases and decreases in size along a corresponding direction (i.e., the white labeled arrow overlaying a length of dendritic structure 418) to create a branched structure. It is appreciated that in other embodiments there may be no protrusions, there may be no islands, there may be no dendritic structures, or there may be any number, including zero, of protrusions, islands of any material included in the dispersive region 406, dendritic structures, or a combination thereof.

In some embodiments, the inverse design process includes a fabrication loss that enforces a minimum feature size, for example, to ensure fabricability of the design. In the illustrated embodiment of photonic demultiplexer 400 illustrated in FIG. 4A and FIG. 4B, material interface pattern 420 is shaped to enforce a minimum feature size within dispersive region 406 such that the plurality of interfaces within the cross-sectional area formed with first material 410 and second material 412 do not have a radius of curvature with a magnitude of less than a threshold size. For example, if the minimum feature size is 150 nm, the radius of curvature for any of the plurality of interfaces have a magnitude of less than the threshold size, which corresponds the inverse of half the minimum feature size (i.e., 1/75 nm⁻¹). Enforcement of such a minimum feature size prevents the inverse design process from generating designs that are not fabricable by considering manufacturing constraints, limitations, and/or yield. In the same or other embodiments, different or additional checks on metrics related to fabricability may be utilized to enforce a minimum width or spacing as a minimum feature size.

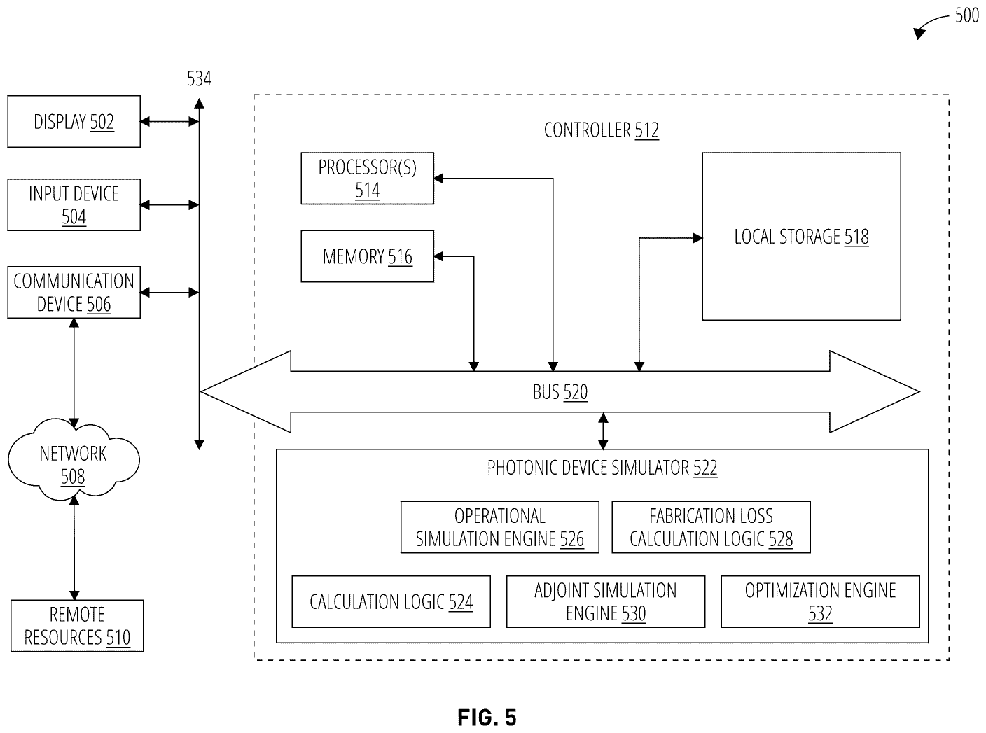

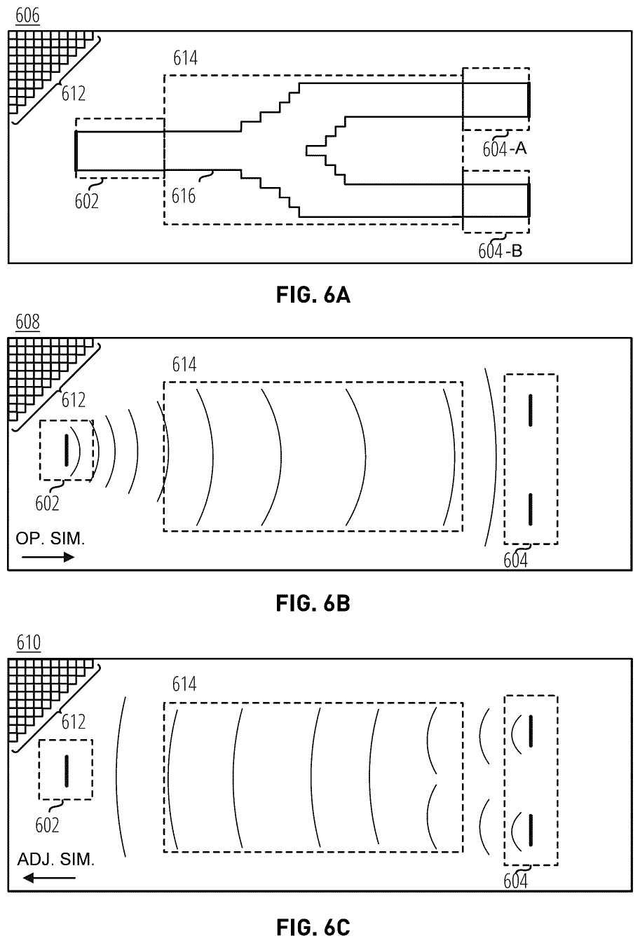

FIG. 5 is a functional block diagram illustrating a computing system for generating a design of a photonic integrated circuit (i.e., photonic device), in accordance with an embodiment of the disclosure. System 500 may be utilized to perform an inverse design process that generates a design with iterative gradient-based optimization that takes into consideration the underlying physics that govern the operation of the photonic integrated circuit. More specifically, system 500 is a design tool that may be utilized to optimize structural parameters (e.g., shape and arrangement of a first material and a second material within the dispersive region of the embodiments described in the present disclosure) of photonic integrated circuits based on first-principles simulations (e.g., electromagnetic simulations to determine a field response of the photonic device to an excitation source) and iterative gradient-based optimization. In other words, system 500 may provide a design obtained via the inverse design process that is substantially replicated (i.e., proportionally scaled) by dispersive region 332 and dispersive region 406 of demultiplexer 316 and photonic demultiplexer 400 illustrated in FIG. 3A and FIG. 4A, respectively.

As illustrated, system 500 includes controller 512, display 502, input device(s) 504, communication device(s) 506, network 508, remote resources 510, bus 534, and bus 520. Controller 512 includes processor 514, memory 516, local storage 518, and photonic device simulator 522. Photonic device simulator 522 includes operational simulation engine 526, fabrication loss calculation logic 528, calculation logic 524, adjoint simulation engine 530, and optimization engine 532. It is appreciated that in some embodiments, controller 512 may be a distributed system.

Controller 512 is coupled to display 502 (e.g., a light emitting diode display, a liquid crystal display, and the like) coupled to bus 534 through bus 520 for displaying information to a user utilizing system 500 to optimize structural parameters of the photonic device (i.e., demultiplexer). Input device 504 is coupled to bus 534 through bus 520 for communicating information and command selections to processor 514. Input device 504 may include a mouse, trackball, keyboard, stylus, or other computer peripheral, to facilitate an interaction between the user and controller 512. In response, controller 512 may provide verification of the interaction through display 502.

Another device, which may optionally be coupled to controller 512, is a communication device 506 for accessing remote resources 510 of a distributed system via network 508. Communication device 506 may include any of a number of networking peripheral devices such as those used for coupling to an Ethernet, Internet, or wide area network, and the like. Communication device 506 may further include a mechanism that provides connectivity between controller 512 and the outside world. Note that any or all of the components of system 500 illustrated in FIG. 5 and associated hardware may be used in various embodiments of the present disclosure. The remote resources 510 may be part of a distributed system and include any number of processors, memory, and other resources for optimizing the structural parameters of the photonic device.

Controller 512 orchestrates operation of system 500 for optimizing structural parameters of the photonic device. Processor 514 (e.g., one or more central processing units, graphics processing units, and/or tensor processing units, etc.), memory 516 (e.g., volatile memory such as DRAM and SRAM, non-volatile memory such as ROM, flash memory, and the like), local storage 518 (e.g., magnetic memory such as computer disk drives), and the photonic device simulator 522 are coupled to each other through bus 520. Controller 512 includes software (e.g., instructions included in memory 516 coupled to processor 514) and/or hardware logic (e.g., application specific integrated circuits, field-programmable gate arrays, and the like) that when executed by controller 512 causes controller 512 or system 500 to perform operations. The operations may be based on instructions stored within any one of, or a combination of, memory 516, local storage 518, physical device simulator 522, and remote resources 510 accessed through network 508.

In the illustrated embodiment, the components of photonic device simulator 522 are utilized to optimize structural parameters of the photonic device (e.g., MUX/DEMUX 114 of FIG. 1, demultiplexer 206 of FIG. 2A, multiplexer 208 of FIG. 2B, demultiplexer 316 of FIG. 3A-FIG. 3D, and photonic demultiplexer 400 of FIG. 4A-FIG. 4B). In some embodiments, system 500 may optimize the structural parameters of the photonic device via, inter alia, simulations (e.g., operational and adjoint simulations) that utilize a finite-difference time-domain (FDTD) method, a finite-difference frequency-domain (FDFD) method, or any other suitable technique to model the field response (e.g., electric and magnetic fields within the photonic device). The operational simulation engine 526 provides instructions for performing an electromagnetic simulation of the photonic device operating in response to an excitation source within a simulated environment. In particular, the operational simulation determines a field response of the simulated environment (and thus the photonic device, which is described by the simulated environment) in response to the excitation source for determining a performance metric of the physical device (e.g., based off an initial description or input design of the photonic device that describes the structural parameters of the photonic device within the simulated environment with a plurality of voxels). The structural parameters may correspond, for example, to the specific design, material compositions, dimensions, and the like of the physical device. Fabrication loss calculation logic 528 provides instructions for determining a fabrication loss, which is utilized to enforce a minimum feature size to ensure fabricability. In some embodiments, the fabrication loss is also used to enforce binarization of the design (i.e., such that the photonic device includes a first material and a second material that are interspersed to form a plurality of interfaces). Calculation logic 524 computes a loss metric determined via a loss function that incorporates a performance loss, based on the performance metric, and the fabrication loss. Adjoint simulation engine 530 is utilized in conjunction with the operational simulation engine 526 to perform an adjoint simulation of the photonic device to backpropagate the loss metric through the simulated environment via the loss function to determine how changes in the structural parameters of the photonic device influence the loss metric. Optimization engine 532 is utilized to update the structural parameters of the photonic device to reduce the loss metric and generate a revised description (i.e., revising the design) of the photonic device.

FIG. 6A-FIG. 6C respectively illustrate non-limiting example embodiments of an initial set up of a simulated environment 606 describing a photonic device, performing an operational simulation of the photonic device in response to an excitation source within the simulated environment 608, and performing an adjoint simulation of the photonic device within the simulated environment 610 according to various aspects of the present disclosure. The initial set up of the simulated environment, 1-dimensional representation of the simulated environment, operational simulation of the physical device, and adjoint simulation of the physical device may be implemented with system 500 illustrated in FIG. 5.

As illustrated in FIG. 6A-FIG. 6C, simulated environment is represented in two-dimensions. However, it is appreciated that other dimensionality (e.g., 3-dimensional space) may also be used to describe simulated environment and the photonic device. In some embodiments, optimization of structural parameters of the photonic device illustrated in FIG. 6A-FIG. 6C may be achieved via an inverse design process including, inter alia, simulations (e.g., operational simulations and adjoint simulations) that utilize a finite-difference time-domain (FDTD) method, a finite-difference frequency-domain (FDFD) method, or any other suitable technique to model the field response (e.g., electric and magnetic field) to an excitation source.

FIG. 6A illustrates a demonstrative simulated environment 606 describing a photonic integrated circuit (i.e., a photonic device such as a waveguide, demultiplexer, and the like), in accordance with a non-limiting example embodiment of the present disclosure. More specifically, in response to receiving an initial description of a photonic device defined by one or more structural parameters (e.g., an input design), a system (e.g., system 500 of FIG. 5) configures a simulated environment 606 to be representative of the photonic device. As illustrated, the simulated environment 606 (and subsequently the photonic device) is described by a plurality of voxels 612, which represent individual elements (i.e., discretized) of the two-dimensional (or other dimensionality) space. Each of the voxels 612 is illustrated as a two-dimensional square; however, it is appreciated that the voxels may be represented as cubes or other shapes in three-dimensional space. It is appreciated that the specific shape and dimensionality of the plurality of voxels 612 may be adjusted dependent on the simulated environment 606 and photonic device being simulated. It is further noted that only a portion of the plurality of voxels 612 are illustrated to avoid obscuring other aspects of the simulated environment 606.

Each of the plurality of voxels 612 may be associated with a structural value, a field value, and a source value. Collectively, the structural values of the simulated environment 606 describe the structural parameters of the photonic device. In one embodiment, the structural values may correspond to a relative permittivity, permeability, and/or refractive index that collectively describe structural (i.e., material) boundaries or interfaces of the photonic device (e.g., material interface pattern 420 of FIG. 4B). For example, an interface 616 is representative of where relative permittivity changes within the simulated environment 606 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxels 612. Thus, the field response may be based, at least in part, on the structural parameters of the photonic device and the excitation source.

In the illustrated embodiment, the photonic device corresponds to an optical demultiplexer having a design region 614 (e.g., corresponding to dispersive region 332 of FIG. 3A, and/or dispersive region 406 of FIG. 4A), in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 602 to a corresponding one of the output ports 604. Thus, input port 602 (e.g., corresponding to input region 302 of FIG. 3A, input region 402 of FIG. 4A, and the like) of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within simulated environment 606). In other words, the excitation source may cause the field response of the photonic device to change, which is dependent on the underlying physics governing the physical domain and the structural parameters of the photonic device. The excitation source originates or is otherwise proximate to input port 602 and is positioned to propagate (or otherwise influence the field values of the plurality of voxels) through the design region 614 towards output ports 604 of the photonic device. In the illustrated embodiment, the input port 602 and output ports 604 are positioned outside of the design region 614. In other words, in the illustrated embodiment, only a portion of the structural parameters of the photonic device is optimizable.

However, in other embodiments, the entirety of the photonic device may be placed within the design region 614 such that the structural parameters may represent any portion or the entirety of the design of the photonic device. The electric and magnetic fields within the simulated environment 606 (and subsequently the photonic device) may change (e.g., represented by field values of the individual voxels that collectively correspond to the field response of the simulated environment) in response to the excitation source. The output ports 604 of the optical demultiplexer may be used for determining a performance metric of the photonic device in response to the excitation source (e.g., power transmission from input port 602 to a specific one of the output ports 604). The initial description of the photonic device, including initial structural parameters, excitation source, performance parameters or metrics, and other parameters describing the photonic device, are received by the system (e.g., system 500 of FIG. 5) and used to configure the simulated environment 606 for performing a first-principles based simulation of the photonic device. These specific values and parameters may be defined directly by a user (e.g., of system 500 in FIG. 5), indirectly (e.g., via controller 512 culling pre-determined values stored in memory 516, local storage 518, or remote resources 510), or a combination thereof.

FIG. 6B illustrates a non-limiting example embodiment of an operational simulation of the photonic device in response to an excitation source within simulated environment 608, in accordance with various aspects of the present disclosure. In the illustrated embodiment, the photonic device is an optical demultiplexer structured to optically separate each of a plurality of distinct wavelength channels included in a multi-channel optical signal received at input port 602 and respectively guide each of the plurality of distinct wavelength channels to a corresponding one of the plurality of output ports 604. The excitation source may be selected (randomly or otherwise) from the plurality of distinct wavelength channels and originates at input port 602 having a specified spatial, phase, and/or temporal profile. The operational simulation occurs over a plurality of time steps, including the illustrated time step. When performing the operational simulation, changes to the field response (e.g., the field value) for each of the plurality of voxels 612 are incrementally updated in response to the excitation source over the plurality of time steps. The changes in the field response at a particular time step are based, at least in part, on the structural parameters, the excitation source, and the field response of the simulated environment 610 at the immediately prior time step included in the plurality of time steps. Similarly, in some embodiments the source value of the plurality of voxels 612 is updated (e.g., based on the spatial profile and/or temporal profile describing the excitation source). It is appreciated that the operational simulation is incremental and that the field values (and source values) of the simulated environment 610 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In one embodiment, the performance metric corresponds to the power transmission at a corresponding one of the output ports 604 mapped to the distinct wavelength channel being simulated by the excitation source. In other words, in some embodiments, the performance metric represents power (at one or more frequencies of interest) in the target mode shape at the specific locations of the output ports 604. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric may be further based on a fabrication loss value that is utilized to enforce a minimum feature size of the photonic device to promote fabricability of the device, and/or other loss values.

FIG. 6C illustrates a non-limiting example embodiment of an adjoint simulation within simulated environment 610 by backpropagating a loss metric, in accordance with various aspects of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 604) or other location that corresponds to a location used when determining the performance metric. The adjoint source(s) is then treated as a physical stimuli or an excitation source during the adjoint simulation. A loss response of the simulated environment 608 is computed for each of the plurality of time steps (e.g., backwards in time) in response to the adjoint source. The loss response collectively refers to loss values of the plurality of voxels 612 that are incrementally updated in response to the adjoint source over the plurality of time steps. The change in loss response based on the loss metric may correspond to a loss gradient, which is indicative of how changes in the field response of the physical device influence the loss metric. The loss gradient and the field gradient may be combined in the appropriate way to determine a structural gradient of the photonic device/simulated environment (e.g., how changes in the structural parameters of the photonic device within the simulated environment influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performed while maintaining fabricability.

One problem in designing physical devices such as the photonic devices described above is that, even if a simulated photonic device is designed that is highly performant, physical realities of manufacturing the designed photonic device may reduce the actual performance of the photonic device as manufactured. For example, differences in operating conditions for a fabrication system, including but not limited to an ambient temperature, erosion, dilation, waveguide thickness, structure out of plane, sidewall angle, a surface roughness of a material to be processed, other material imperfections of a material to be processed, misalignment of the fabrication system, and optical aberrations within the fabrication system, may cause differences to be introduced between the structure of the physical device as designed and the structure of the physical device as manufactured. That is, the different operating conditions may cause the features of the physical device to be smaller, larger, or differently shaped than the design that is provided to the fabrication system. What is desired are design techniques that will result in designs for physical devices that are highly performant and are also robust to changes in operating conditions of the fabrication system.

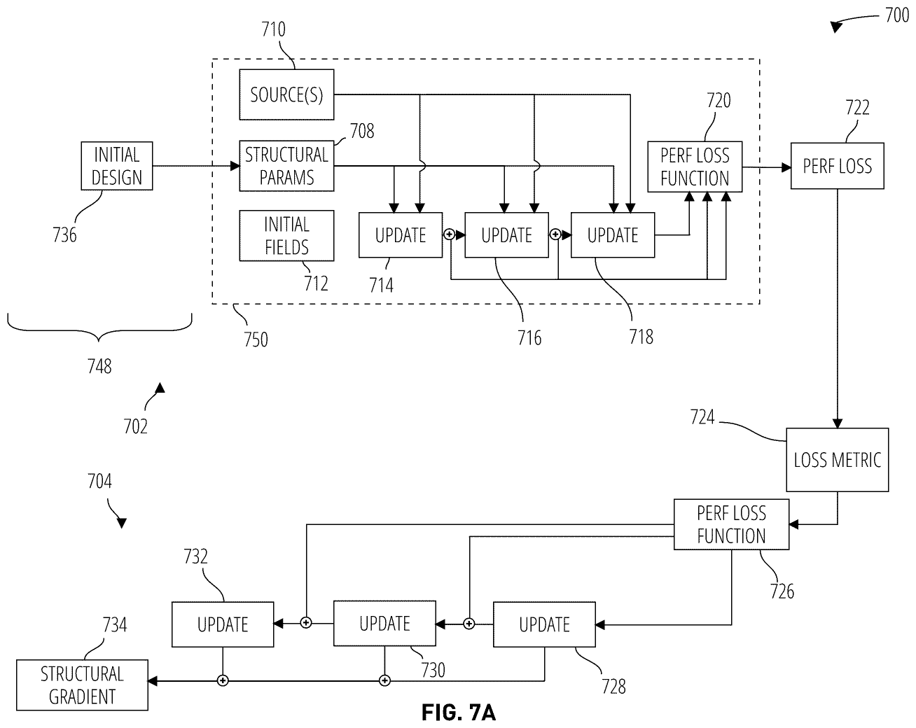

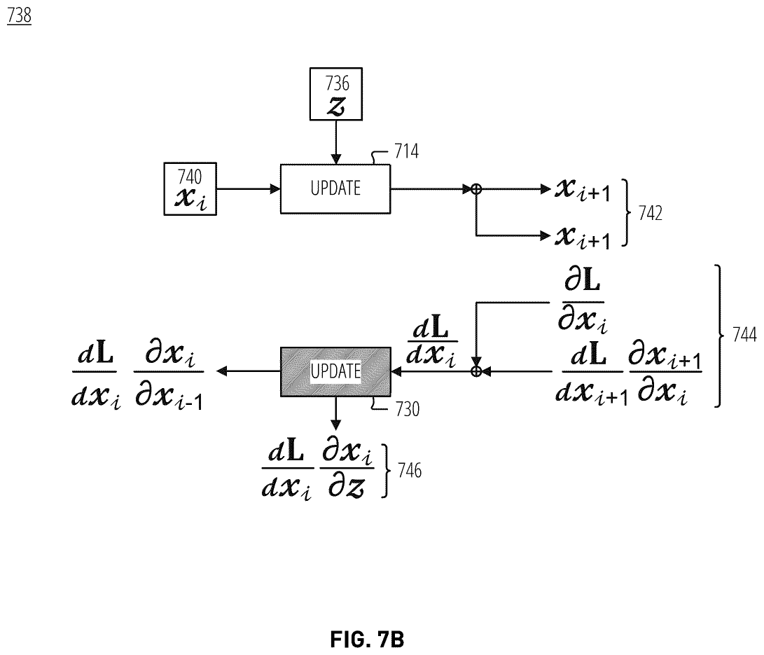

FIG. 7A is a flow chart 700 illustrating example time steps for an operational simulation 702 and an adjoint simulation 704, in accordance with various aspects of the present disclosure. Flow chart 700 is one possible implementation that a system may use to perform the operational simulation 702 and adjoint simulation 704 of the simulated environment describing a photonic integrated circuit (e.g., an optical device operating in an electromagnetic domain such a photonic demultiplexer). In the illustrated embodiment, the operational simulation 702 utilizes a finite-difference time-domain (FDTD) method to model the field response (both electric and magnetic) or loss response at each of a plurality of voxels for a plurality of time steps in response to physical stimuli corresponding to an excitation source and/or adjoint source.

As illustrated in FIG. 7A, the operational simulation 702 includes a configuration portion 748 and a simulation portion 750. In the configuration portion 748, an initial design 736 is received that includes structural parameters for a physical device such as a photonic device to be simulated. The structural parameters may represent the exact intended design for the physical device, or may represent a design for the physical device as would be fabricated under a nominal or default set of operating conditions. In some embodiments, the initial design 736 may include the structural parameters and an indication of the assumed operating conditions under which the structural parameters would have been fabricated. In some embodiments, the initial design 736 may include ranges of operating conditions under which the structural parameters should be analyzed by the remainder of the operational simulation 702.

After receiving the initial design 736, the operational simulation 702 generates a plurality of perturbed structural parameters 706. Each perturbed structural parameter 706 represents the structural parameters of the initial design 736 as they would be fabricated by the fabrication system under a different set of operating conditions. A fabrication model may be used to simulate the fabrication of the photonic device based on the initial structural parameters and the operating conditions in order to generate the perturbed structural parameters 706. For example, if an ambient temperature for a set of operating conditions is higher than a nominal or default ambient temperature, a corresponding perturbed structural parameter 706 may include features that have corners that are rounder or otherwise less precise than those that would be fabricated under the nominal or default ambient temperature.

In some embodiments, ranges of values for each of the operating conditions may be predetermined. Any suitable technique may then be used to determine the sets of operating conditions for generating the perturbed structural parameters 706. For example, values within the predetermined ranges of values may be stochastically sampled for each of the operating conditions, and combinations of the stochastically sampled values may be used as the sets of operating conditions. As another example, values within the predetermined ranges of values may be uniformly sampled for each operating condition, and combinations of the uniformly sampled values may be used as the sets of operating conditions. As yet another example, a sensitivity for each operating condition may be determined, and then values within the predetermined ranges of values may be sampled in a non-linear manner based on the determined sensitivities. The sensitivities may be determined by analyzing the results obtained with a plurality of sets of operating conditions that vary each operating condition separately.

After the perturbed structural parameters 706 are determined, the operational simulation 702 proceeds to a simulation portion 750, which is performed separately for each of the perturbed structural parameters 706. The simulation portion 750 occurs over a plurality of time-steps (e.g., from an initial time step to a final time step over a pre-determined or conditional number of time steps having a specified time step size) and models changes (e.g., from the initial field values 712) in electric and magnetic fields of a plurality of voxels describing the simulated environment and/or photonic device that collectively correspond to the field response. More specifically, update operations (e.g., update operation 714, update operation 716, and update operation 718) are iterative and based on the field response, structural parameters 708 (that is, for a selected one of the perturbed structural parameters 706), and one or more excitation sources 710. Each update operation is succeeded by another update operation, which are representative of successive steps forward in time within the plurality of time steps. For example, update operation 716 updates the field values 740 (see, e.g., FIG. 7B) based on the field response determined from the previous update operation 714, excitation sources 710, and the structural parameters 708. Similarly, update operation 718 updates the field values 742 (see, e.g., FIG. 7B) based on the field response determined from update operation 716. In other words, at each time step of the operational simulation the field values (and thus field response) are updated based on the previous field response and structural parameters of the photonic device.

Once the final time step of the simulation portion 750 is performed, a performance loss function 720 is used to determine a performance loss value 722 associated with the selected perturbed structural parameter 706. The performance loss values 722 for each of the perturbed structural parameters 706 are then combined into a total performance loss value that can be used to determine (or used as) a loss metric 724. The performance loss values 722 may be combined using any suitable technique. For example, in some embodiments, a linear combination of the performance loss values 722 may be used as the total performance loss value. As another example, in embodiments wherein a non-linear sampling of the operating conditions was performed based on sensitivities associated with each operating condition, a non-linear combination of the performance loss values 722 based on the sensitivities may be performed to create the total performance loss value.

From the loss metric 724, loss gradients may be determined at block 726. The loss gradients determined from block 726 may be treated as adjoint or virtual sources (e.g., physical stimuli or excitation source originating at an output region or port) which are backpropagated in reverse (from the final time step incrementally through the plurality of time steps until reaching the initial time step via update operation 728, update operation 732, and update operation 730) to determine structural gradient 734. Because it is determined based on the total performance loss value, the structural gradient 734 is associated with the initial design 736, as opposed to an individual perturbed structural parameter 706. This allows the initial design 736 to be updated instead of having to individually process each of the perturbed structural parameters 706 and propagate changes in the design back to the initial design 736, thus eliminating a large amount of unnecessary computation.

In the illustrated embodiment, the FDTD solve (e.g., simulation portion 750 of the operational simulation 702) and backward solve (e.g., adjoint simulation 704) problem are described pictorially, from a high-level, using only “update” and “loss” operations as well as their corresponding gradient operations. The simulation is set up initially in which the structural parameters, physical stimuli (i.e., excitation source), and initial field states of the simulated environment (and photonic device) are provided (e.g., via an initial description and/or input design). As discussed previously, the field values are updated in response to the excitation source based on the structural parameters. More specifically, the update operation is given by ϕ, where [symbol] =ϕ( [symbol] , [symbol] , [symbol] ) for [symbol] =1, . . . , [symbol] . Here, [symbol] corresponds to the total number of time steps (e.g., the plurality of time steps) for the operational simulation, where xi corresponds to the field response (the field value associated with the electric and magnetic fields of each of the plurality of voxels) of the simulated environment at time step [symbol] , [symbol] corresponds to the excitation source(s) (the source value associated with the electric and magnetic fields for each of the plurality of voxels) of the simulated environment at time step [symbol] , and [symbol] corresponds to the structural parameters describing the topology and/or material properties of the physical device (e.g., relative permittivity, index of refraction, and the like).

It is noted that using the FDTD method, the update operation may specifically be stated as:

$$ϕ ( {x}_{i} , , z ) = A ( ) {x}_{i} + B ( )$$

That is to say the FDTD update is linear with respect to the field and source terms. Concretely, A( [symbol] )∈ [symbol] ^{N×N} and B( [symbol] )∈ [symbol] ^{N×N} are linear operators which depend on the structure parameters, [symbol] , and act on the fields, [symbol] , and the sources, [symbol] , respectively. Here, it is assumed that [symbol] , [symbol] ∈ [symbol] ^{N} where N is the number of FDTD field components in the operational simulation. Additionally, the loss operation (e.g., loss function) may be given by L=ƒ( [symbol] , . . . , xₙ), which takes as input the computed fields and produces a single, real-valued scalar (e.g., the loss metric) that can be reduced and/or minimized.

In terms of revising or otherwise optimizing the structural parameters of the physical device, the relevant quantity to produce is

$$\frac{dL}{dz} ,$$

which is used to describe the influence of changes in the structural parameters of the initial design 736 on the loss value and is denoted as the structural gradient 734 illustrated in FIG. 7A.

FIG. 7B is a chart 738 illustrating the relationship between the update operation for the operational simulation and the adjoint simulation (e.g., backpropagation), in accordance with an embodiment of the present disclosure. More specifically, FIG. 7B summarizes the operational and adjoint simulation relationships that are involved in computing the structural gradient,

$$\frac{dL}{dz} ,$$

which include

$$\frac{\partial L}{\partial {x}_{i}} , \frac{\partial {x}_{i + 1}}{\partial {x}_{i}} , \frac{dL}{{dx}_{i}} , and \frac{\partial {x}_{i}}{\partial z} .$$

The update operation 716 of the operational simulation 702 updates the field values 740, [symbol] , of the plurality of voxels at the [symbol] th time step to the next time step (i.e., [symbol] +1 time step), which correspond to the field values 742, [symbol] . The gradients 744 are utilized to determine

$$\frac{\partial L}{\partial {x}_{i}}$$

for the backpropagation (e.g., update operation 732 backwards in time), which combined with the gradients 746 are used, at least in part, to calculate the structural gradient,

$$\frac{dL}{dz} \cdot \frac{\partial L}{\partial {x}_{i}}$$

is the contribution of each field to the loss metric, L. It is noted that this is the partial derivative, and therefore does not take into account the causal relationship of [symbol] → [symbol] . Thus,

$$\frac{\partial {x}_{i + 1}}{\partial {x}_{i}}$$

is utilized which encompasses the [symbol] → [symbol] relationship. The loss gradient,

$$\frac{dL}{{dx}_{i}} ,$$

may also be used to compute the structural gradient,

$$\frac{dL}{dz} ,$$

and corresponds to the total derivative of the field with respect to loss value, L. The loss gradient,

$$\frac{dL}{{dx}_{i}} ,$$

at a particular time step, i, is equal to the summation of

$$\frac{\partial L}{\partial } + \frac{dL}{{dx}_{i + 1}} \frac{\partial {x}_{i + 1}}{\partial {x}_{i}} .$$

### Finally,

$$\frac{\partial {x}_{i}}{\partial z} ,$$

which corresponds to the field gradient, is used which is the contribution to

$$\frac{dL}{dz}$$

from each time/update step.

In particular, the memory footprint to directly compute

$$\frac{\partial L}{\partial {x}_{i}} and \frac{\partial L}{\partial z}$$

is so large that it is difficult to store more than a handful of state Tensors. The state Tensor corresponds to storing the values of all of the FDTD cells (e.g., the plurality of voxels) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be desired to store the fields, xᵢ, for all time steps, i. This is because, for most choices of ƒ, the gradient will be a function of the arguments of ƒ. This difficulty is compounded by the fact that the values of

$$\frac{\partial L}{\partial {x}_{i}}$$

for larger values of [symbol] are needed before the values for smaller [symbol] due to the incremental updates of the field response and/or through backpropagation of the loss metric, which may prevent the use of schemes that attempt to store only the values

$$\frac{\partial L}{\partial {x}_{i}} ,$$

at an immediate time step.

An additional difficulty is further illustrated when computing the structural gradient,

$$\frac{\partial L}{\partial z} ,$$

which is given by:

$$\frac{\partial L}{\partial z} = {\sum }_{i} \frac{d L}{d} \frac{\partial }{\partial z} .$$

For completeness, the full form of the first term in the sum,

$$\frac{\partial L}{\partial z} ,$$

is expressed as:

$$\frac{d L}{d} = \frac{\partial L}{\partial } + \frac{d L}{d {+ 1}_{}} \frac{\partial {+ 1}_{}}{\partial }$$

Based on the definition of $ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 732), which can be expressed as:

$$\frac{d L}{d} = \frac{\partial L}{\partial } + \frac{d L}{d {+ 1}_{}} A ( z ) ,$$

$$or$$

$${∇}_{{x}_{i}} L = {A ( z )}^{T} {∇}_{{x}_{i + 1}} L + \frac{\partial {L}^{T}}{\partial }$$

The adjoint update is the backpropagation of the loss gradient (e.g., from the loss metric) from later to earlier time steps and may be referred to as a backwards solve for

$$\frac{d L}{{dx}_{i}} .$$

More specifically, the loss gradient may initially be based upon the backpropagation of a loss metric determined from the operational simulation with the loss function. The second term in the sum of the structural gradient,

$$\frac{\partial L}{\partial z} ,$$

corresponds to the field gradient and is denoted as:

$$\frac{\partial }{\partial z} = \frac{d ϕ ( {- 1}_{} , {i - 1}_{} , z )}{d z} = \frac{d A ( z )}{dz} {- 1}_{} + \frac{d B ( z )}{d z} {i - 1}_{} ,$$

for the particular form of ϕ described by the first equation above. Thus, each term of the sum associated

$$\frac{\partial L}{\partial z}$$

depends on both

$$\frac{d L}{d {x}_{{i}_{0}}}$$

for [symbol] >= [symbol] ₀ and [symbol] for [symbol] < [symbol] . Since the dependency chains of these two terms are in opposite directions, it is concluded that computing

$$\frac{\partial L}{\partial z}$$

in this way utilizes the storage of [symbol] values for all of [symbol] . In some embodiments, the need to store all field values may be mitigated by a reduced representation of the fields.

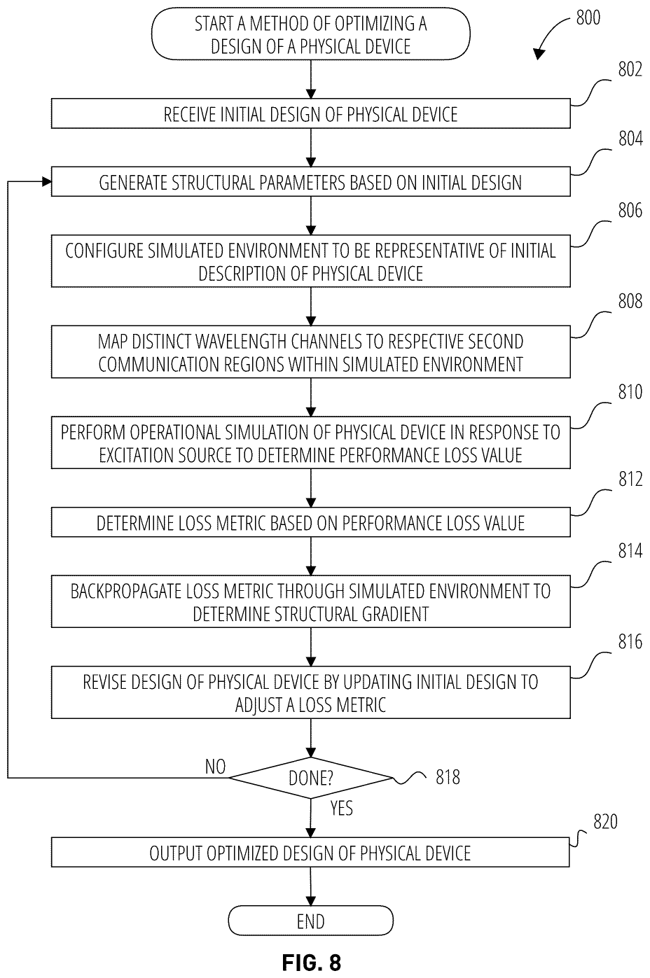

FIG. 8 is a flowchart that illustrates a non-limiting example embodiment of a method 800 for generating a design of physical device such as a photonic integrated circuit, in accordance with various aspects of the present disclosure. It is appreciated that method 800 is an inverse design process that may be accomplished by performing operations with a system to perform iterative gradient-based optimization of a loss metric determined from a loss function that includes at least a performance loss and a fabrication loss. In the same or other embodiments, method 800 may be included as instructions provided by at least one machine-accessible storage medium (e.g., non-transitory memory) that, when executed by a machine, will cause the machine to perform operations for generating and/or improving the design of the photonic integrated circuit. It is further appreciated that the order in which some or all of the process blocks appear in method 800 should not be deemed limiting. Rather, one of ordinary skill in the art having the benefit of the present disclosure will understand that some of the process blocks may be executed in a variety of orders not illustrated, or even in parallel.

From a start block, the method 800 proceeds to block 802, where an initial design 736 of a physical device such as a photonic integrated circuit is received. In some embodiments, the physical device may be expected to have a certain functionality (e.g., perform as an optical demultiplexer) after optimization. This expected functionality, including but not limited to expected s-parameters and/or other expected operating characteristics, may be provided in a design specification on which the initial design 736 is based. The initial design 736 may describe structural parameters of the physical device within a simulated environment. The simulated environment may include a plurality of voxels that collectively describe the structural parameters of the physical device. Each of the plurality of voxels is associated with a structural value to describe the structural parameters, a field value to describe the field response (e.g., the electric and magnetic fields in one or more orthogonal directions) to physical stimuli (e.g., one or more excitation sources), and a source value to describe the physical stimuli. In some embodiments the initial design 736 may be a first description of the physical device in which values for the structural parameters may be random values or null values outside of input and output regions such that there is no bias for the initial (e.g., first) design. It is appreciated that the initial description or input design may be a relative term. Thus, in some embodiments an initial description may be a first description of the physical device described within the context of the simulated environment (e.g., a first input design for performing a first operational simulation).

However, in other embodiments, the term initial description may refer to an initial description of a particular cycle (e.g., of performing an operational simulation 702, operating an adjoint simulation 704, and updating the structural parameters). In such an embodiment, the initial design 736 or design of that particular cycle may correspond to a revised description or refined design (e.g., generated from a previous cycle). In some embodiments, the simulated environment includes a design region that includes a portion of the plurality of voxels which have structural parameters that may be updated, revised, or otherwise changed to optimize the structural parameters of the physical device. In the same or other embodiments, the structural parameters are associated with geometric boundaries and/or material compositions of the physical device based on the material properties (e.g., relative permittivity, index of refraction, etc.) of the simulated environment.

At block 804, perturbed structural parameters 706 are generated based on the initial design 736. As discussed above, sets of operating conditions may be generated within the ranges of valid operating conditions using any suitable technique, including but not limited to stochastic sampling, linear sampling, and non-linear sampling based on sensitivities. The sets of operating conditions may then be used to simulate fabrication based on initial structural parameters within the initial design 736 in order to generate the perturbed structural parameters 706.

The method 800 then proceeds to a for-loop defined between a for-loop start block 824 and a for-loop end block 826, wherein each of the perturbed structural parameters 706 is processed. From the for-loop start block 824, the method 800 proceeds to block 806, where a simulated environment is configured to be representative of the perturbed structural parameters of a physical device (e.g., photonic device). Once the perturbed structural parameters have been received or otherwise obtained, the simulated environment is configured (e.g., the number of voxels, shape/arrangement of voxels, and specific values for the structural value, field value, and/or source value of the voxels are set based on the perturbed structural parameters).

In some embodiments the simulated environment includes a design region optically coupled between a first communication region and a plurality of second communication regions. In some embodiments, the first communication region may correspond to an input region or port (e.g., where an excitation source originates), while the second communication may correspond to a plurality of output regions or ports (e.g., when designing an optical demultiplexer that optically separates a plurality of distinct wavelength channels included in a multi-channel optical signal received at the input port and respectively guiding each of the distinct wavelength channels to a corresponding one of the plurality of output ports). However, in other embodiments, the first communication region may correspond to an output region or port, while the plurality of second communication regions corresponds to a plurality of input ports or region (e.g., when designing an optical multiplexer that optically combines a plurality of distinct wavelength signals received at respective ones of the plurality of input ports to form a multi-channel optical signal that is guided to the output port).

Block 808 shows mapping each of a plurality of distinct wavelength channels to a respective one of the plurality of second communication regions. The distinct wavelength channels may be mapped to the second communication regions by virtue of the initial design 736 of the physical device. For example, a loss function may be chosen that associates a performance metric of the physical device with power transmission from the input port to individual output ports for mapped channels. In one embodiment, a first channel included in the plurality of distinct wavelength channels is mapped to a first output port, meaning that the performance metric of the physical device for the first channel is tied to the first output port. Similarly, other output ports may be mapped to the same or different channels included in the plurality of distinct wavelength channels such that each of the distinct wavelength channels is mapped to a respective one of the plurality of output ports (i.e., second communication regions) within the simulated environment. In one embodiment, the plurality of second communication regions includes four regions and the plurality of distinct wavelength channels includes four channels that are each mapped to a corresponding one of the four regions. In other embodiments, there may be a different number of the second communication regions (e.g., 8 regions) and a different number of channels (e.g., 8 channels) that are each mapped to a respective one of the second communication regions.

Block 810 illustrates performing an operational simulation of the physical device within the simulated environment operating in response to one or more excitation sources to determine a performance loss value. More specifically, in some embodiments an electromagnetic simulation is performed in which a field response of the photonic integrated circuit is updated incrementally over a plurality of time steps to determine how the how the field response of the physical device changes due to the excitation source. The field values of the plurality of voxels are updated in response to the excitation source and based, at least in part, on the structural parameters of the integrated photonic circuit. Additionally, each update operation at a particular time step may also be based, at least in part, on a previous (e.g., immediately prior) time step.

Consequently, the operational simulation simulates an interaction between the photonic device (i.e., the photonic integrated circuit) and a physical stimuli (i.e., one or more excitation sources) to determine a simulated output of the photonic device (e.g., at one or more of the output ports or regions) in response to the physical stimuli. The interaction may correspond to any one of, or combination of a perturbation, retransmission, attenuation, dispersion, refraction, reflection, diffraction, absorption, scattering, amplification, or otherwise of the physical stimuli within electromagnetic domain due, at least in part, to the structural parameters of the photonic device and underlying physics governing operation of the photonic device. Thus, the operational simulation simulates how the field response of the simulated environment changes due to the excitation source over a plurality of time steps (e.g., from an initial to final time step with a pre-determined step size).

In some embodiments, the simulated output may be utilized to determine one or more performance metrics of the physical device. For example, the excitation source may correspond to a selected one of a plurality of distinct wavelength channels that are each mapped to one of the plurality of output ports. The excitation source may originate at or be disposed proximate to the first communication region (i.e., input port) when performing the operational simulation. During the operational simulation, the field response at the output port mapped to the selected one of the plurality of distinct wavelength channels may then be utilized to determine a simulated power transmission of the photonic integrated circuit for the selected distinct wavelength channel. In other words, the operational simulation may be utilized to determine the performance metric that includes determining a simulated power transmission of the excitation source from the first communication region, through the design region, and to a respective one of the plurality of second communication regions mapped to the selected one of the plurality of distinct wavelength channels. In some embodiments, the excitation source may cover the spectrum of all of the plurality of output ports (e.g., the excitation source spans at least the targeted frequency ranges for the bandpass regions for each of the plurality of distinct wavelength channels as well as the corresponding transition band regions, and at least portions of the corresponding stopband regions) to determine a performance metric (i.e., simulated power transmission) associated with each of the distinct wavelength channels for the photonic integrated circuit. In some embodiments, one or more frequencies that span the passband of a given one of the plurality of distinct wavelength channels is selected randomly to optimize the design (e.g., batch gradient descent while having a full width of each passband including ripple in the passband that meets the target specifications). In the same or other embodiments, each of the plurality of distinct wavelength channels has a common bandwidth with different center wavelengths. The performance metric may then be used to generate a performance loss value for the set of perturbed structural parameters 706. The performance loss value may correspond to a difference between the performance metric and a target performance metric of the physical device.

The method 800 then proceeds to the for-loop end block 826. If further perturbed structural parameters 706 remain to be processed, then the method 800 returns to for-loop start block 824 to process the next set of perturbed structural parameters 706. Otherwise, if performance loss values have been obtained for all of the perturbed structural parameters 706, then the method advances to block 822.

At block 822, the performance loss values 722 are combined to generate a combined performance loss value. As discussed above, any suitable technique may be used to combine the separate performance loss values, including but not limited to linear combination and non-linear combination based on sensitivities for each operating condition.

Block 812 shows determining a loss metric based on the combined performance loss value and a fabrication loss associated with a minimum feature size. In some embodiments the loss metric is determined via a loss function that includes both the performance loss value and the fabrication loss as input values. In some embodiments, a minimum feature size for the design region of the simulated environment may be provided to promote fabricability of the design generated by the inverse design process. The fabrication loss is based, at least in part, on the minimum feature size and the perturbed structural parameters of the design region. More specifically, the fabrication loss enforces the minimum feature size for the design such that the design region does not have structural elements with a diameter less than the minimum feature size. This helps this system provide designs that meet certain fabricability and/or yield requirements. In some embodiments the fabrication loss also helps enforce binarization of the design (i.e., rather than mixing the first and second materials together to form a third material, the design includes regions of the first material and the second material that are inhomogeneously interspersed).

In some embodiments the fabrication loss is determined by generating a convolution kernel (e.g., circular, square, octagonal, or otherwise) with a width equal to the minimum feature size. The convolution kernel is then shifted through the design region of the simulated environment to determine voxel locations (i.e., individual voxels) within the design region that fit the convolution kernel within the design region without extending beyond the design region. The convolution kernel is then convolved at each of the voxel locations with the structural parameters associated with the voxel locations to determine first fabrication values. The structural parameters are then inverted and the convolution kernel is convolved again at each of the voxel locations with the inverted structural parameters to determine second fabrication values. The first and second fabrication values are subsequently combined to determine the fabrication loss for the design region. This process of determining the fabrication loss may promote structural elements of the design region having a radius of curvature less having a magnitude of less than a threshold size (i.e., inverse of half the minimum feature size).

Block 814 illustrates backpropagating the loss metric via the loss function through the simulated environment to determine an influence of changes in the structural parameters on the loss metric (i.e., structural gradient). The loss metric is treated as an adjoint or virtual source and is backpropagated incrementally from a final time step to earlier time steps in a backwards simulation to determine the structural gradient of the physical device.

Block 816 shows revising a design of the physical device (e.g., generated a revised description) by updating the structural parameters of the initial design 736 to adjust the loss metric. In some embodiments, adjusting for the loss metric may reduce the loss metric. However, in other embodiments, the loss metric may be adjusted or otherwise compensated in a manner that does not necessarily reduce the loss metric, In one embodiment, adjusting the loss metric may maintain fabricability while providing a general direction within the parameterization space to obtain designs that will ultimately result in increased performance while also maintaining device fabricability and targeted performance metrics. In some embodiments, the revised description is generated by utilizing an optimization scheme after a cycle of operational and adjoint simulations via a gradient descent algorithm, Markov Chain Monte Carlo algorithm, or other optimization techniques. Put in another way, iterative cycles of simulating the physical device, determining a loss metric, backpropagating the loss metric, and updating the structural parameters to adjust the loss metric may be successively performed until the loss metric substantially converges such that the difference between the performance metric and the target performance metric is within a threshold range while also accounting for fabricability and binarization due to the fabrication loss. By using multiple perturbed structural parameters to determine the performance loss value, the update of the initial design 736 will also account for robustness to differing operating conditions during fabrication. In some embodiments, the term “converges” may simply indicate the difference is within the threshold range and/or below some threshold value.

At decision block 818, a determination is made regarding whether the loss metric substantially converges such that the difference between the performance metric and the target performance metric is within a threshold range. Iterative cycles of simulating the physical device with the excitation source selected from the plurality of distinct wavelength channels, backpropagating the loss metric, and revising the design by updating the structural parameters to reduce the loss metric until the loss metric substantially converges such that the difference between the performance metric and the target performance metric is within a threshold range. In some embodiments, the structural parameters of the design region of the integrated photonic circuit are revised when performing the cycles to cause the design region of the photonic integrated circuit to optically separate each of the plurality of distinct wavelength channels from a multi-channel optical signal received via the first communication region and guide each of the plurality of distinct wavelength channels to the corresponding one of the plurality of second communication regions.

If the determination is that the loss metric has not converged, then the result of decision block 818 is NO, and the method 800 returns to block 804 to iterate on the revised initial design 736. Otherwise, if the determination is that the loss metric has converged, then the result of decision block 818 is YES and the method 800 advances to block 820.

Block 820 illustrates outputting an optimized design of the physical device in which the structural parameters have been updated to have the difference between the performance metric and the target performance metric within a threshold range while also enforcing a minimum feature size and binarization. The method 800 then proceeds to an end block and terminates.

Using the techniques described above to determine a design for a dispersive region 332 in an optoelectronic device can result in highly performant devices with non-intuitive designs. However, the performance of optoelectronic devices can be variable under different operating conditions. For example, the first material 342 and second material 344 making up the active layer 338 may have refractive indices that vary based on temperature. Even small differences in the refractive indices induced by temperature differences during operation may have significant impacts on the performance of the optoelectronic device, particularly given the non-intuitive nature of the generated designs.

One solution for ensuring high performance of the optoelectronic device is to incorporate a heater into the device. By including a heater in the device and designing the optoelectronic device to operate at a temperature higher than an expected ambient temperature (such that the heater can adjust the actual operating temperature of the device from the ambient temperature up to the operating temperature for which the device was designed), highly consistent performance of the device can be obtained.

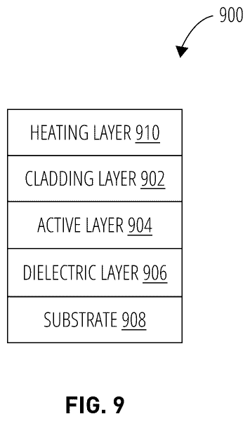

FIG. 9 is a vertical schematic of a stack of layers in an optoelectronic device that includes a heater according to various aspects of the present disclosure. The stack 900 includes elements similar to the layers illustrated in FIG. 3B-FIG. 3D, with the cladding layer 902, active layer 904, dielectric layer 906, and substrate 908 being similar to the cladding layer 340, active layer 338, dielectric layer 336, and substrate 334. Compared to the previous illustrations, the stack 900 has added a heating layer 910. In some embodiments, the heating layer 910 may be horizontally co-extensive with the dispersive region 332 or with the entire width 320 and length 322 of the device. In some embodiments, the heating layer 910 may be horizontally co-extensive with a smaller portion of the device.

FIG. 9 illustrates a non-limiting example embodiment wherein the heating layer 910 is positioned on top of the cladding layer 902. This position may be appropriate if the heating layer 910 is provided as an addition to a previously fabricated stack as illustrated in FIG. 3B-FIG. 3D. In other embodiments, the heating layer 910 may be positioned at another location in the stack 900. For example, in some embodiments, the heating layer 910 may be an additional layer of circuitry created during the same fabrication process (e.g., a photolithography process), and so may be between the substrate 908 and the dielectric layer 906, between the active layer 904 and the cladding layer 902, or in any other suitable location. In some embodiments, the features of the heating layer 910 may not be located in a separate layer, but may instead be provided as an interleaved portion of another layer in the stack 900.

Any suitable type of heater may be used in the heating layer 910. Typically, the heater is simply a resistor of appropriate size and shape. In some embodiments, other types of heaters may be used. For example, an optical absorber may receive light (including but not limited to a portion of the light signal received at input region 302, or a controllable light received at another input port dedicated to heating) and to increase the temperature of the device using the received light.

By using inverse design techniques to design the heating layer 910 as well as the dispersive region 332, highly performant heaters that are particularly effective in adjusting the operating temperature of the optoelectronic device at minimum cost in terms of energy consumed, effect on other portions of surrounding devices, and other optimization goals when compared to merely using a heating element of a predetermined size and/or shape may be designed. For example, the size, shape, location, and number of heating element(s) may be adjusted in an inverse design process in order to maximize various aspects of the performance of the heaters and/or the optoelectronic device. Further, by using inverse design techniques to design both the heating layer 910 and the dispersive region 332, the overall device may be optimized for a desired temperature sensitivity (i.e., optimizing for a large or small change in optoelectronic performance per degree change in temperature, as desired).

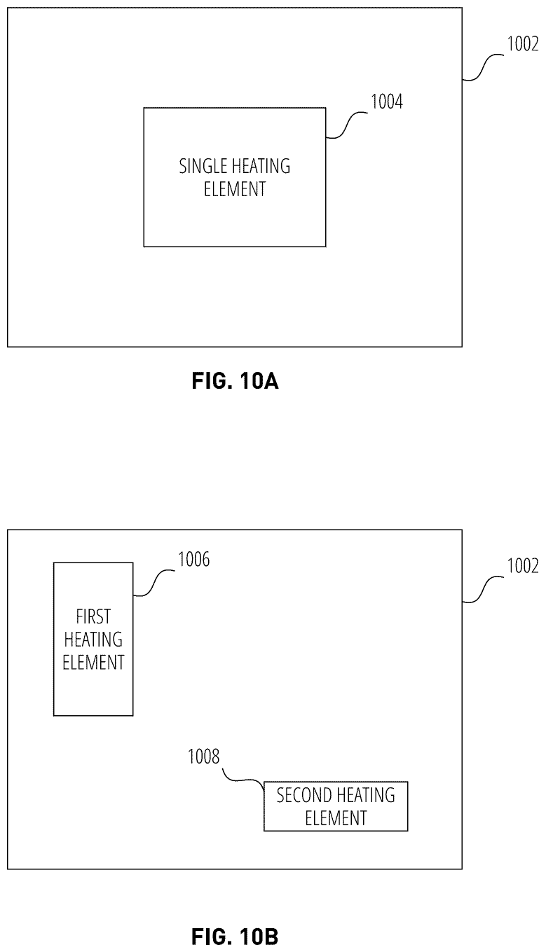

FIG. 10A and FIG. 10B are schematic illustrations that show two non-limiting examples of designs for heating elements that have been generated by or may be adjusted using inverse design techniques according to various aspects of the present disclosure. In FIG. 10A and FIG. 10B, a heating design region 1002 is shown that may cover the width 320 and length 322 of the entire device, the width 324 and length 326 of the dispersive region 332, or any other suitable portion of the design of the device. In FIG. 10A, a shape and location of a single heating element 1004, such as a resistor or any of the other types of heating elements discussed above, is shown. During an inverse design process, the width of the single heating element 1004 may be changed, the length of the single heating element 1004 may be changed, the location of the center of the single heating element 1004 may be changed, or any other suitable change may be made. In FIG. 10B, shapes and locations of a first heating element 1006 and a second heating element 1008 are shown. As with the single heating element 1004, the lengths, widths, centers, or any other parameters defining the design of the first heating element 1006 and the second heating element 1008 may be adjusted during the inverse design process.

While the single heating element 1004, first heating element 1006, and second heating element 1008 are illustrated as rectangles for the ease of illustration, these shapes should not be seen as limiting. For example, in some embodiments, the heating elements may be wires (i.e., long, narrow elements), with a length and pattern of the wires being determined during the design process. As another example, in some embodiments, the borders of the heating elements may be curved or may have an arbitrary shape determined voxel-by-voxel during the inverse design process in a way similar to the determination of the shapes of features in the dispersive region 332. Also, though FIG. 10A illustrates one heating element while FIG. 10B illustrates two heating elements, in some embodiments, the number of heating elements may be adjusted during the inverse design process, such that separate heating elements may be added or removed during the process. Finally, though not illustrated, each heating element may be coupled to an energy source in one or more locations, such as two or more pins to be connected to a power circuit. In some embodiments, the location and/or number of pins to be connected to the power circuit may be adjusted during the inverse design process as well.

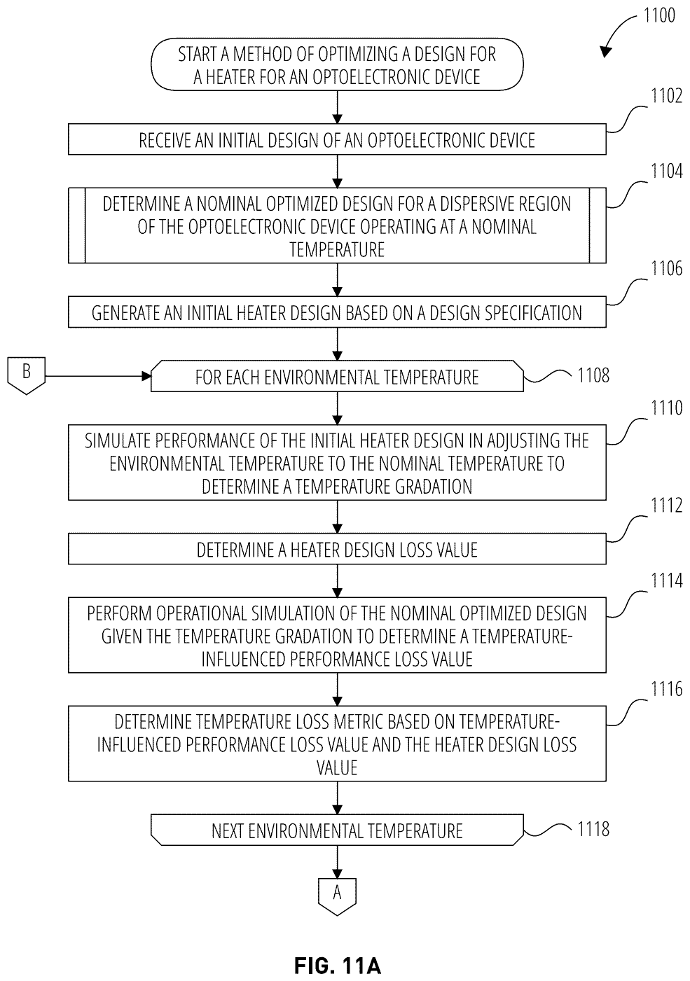

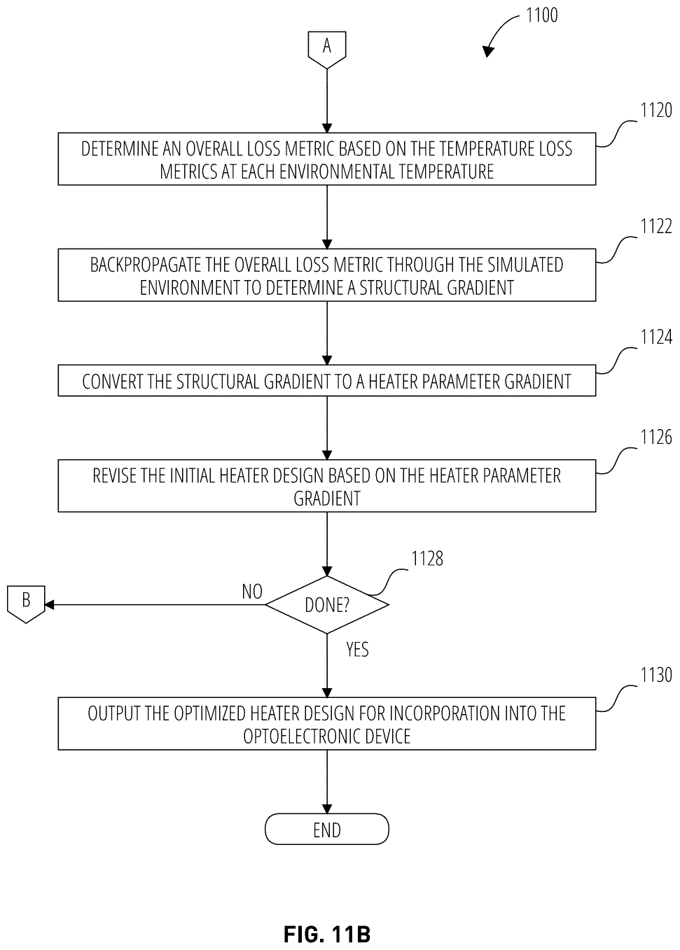

FIG. 11A-FIG. 11B are a flowchart that illustrates a non-limiting example embodiment of optimizing a design for a heater for an optoelectronic device according to various aspects of the present disclosure. The method 1100 may be performed using the system 500 illustrated in FIG. 5, or any other suitable system.

Though styled as optimization of the heater design, it should be noted that the method 1100 includes an optimization of the design of the dispersive region of the optoelectronic device as well. As such, it can be said that the method 1100 is a co-optimization of the design of the dispersive region and the heater design. By co-optimizing the heater and the dispersive region, even more highly performant designs for the heater and the dispersive region can be obtained. For example, the inverse design process may determine that temperature fluctuations from the nominal operating temperature in certain areas of the design do not unduly impact performance due to low field values, due to the nature of the shape of the design, or for other reasons, and so heater performance in that area of the design is not as important as other areas, while temperature fluctuations in areas of the design that do impact performance are minimized. As another example, the metal included in the heater design may be optically absorptive, and so co-optimization of the heater and the dispersive region allows the optimizer to automatically find a balance between optical loss and heater performance.

From a start block, the method 1100 proceeds to block 1102, where an initial design 736 of an optoelectronic device is received, and to subroutine block 1104, where a nominal optimized design for a dispersive region 332 of the optoelectronic device operating at a nominal temperature is determined. Block 1102 and subroutine block 1104 combined are similar to the method 800 illustrated in FIG. 8 and described above. One difference is that the initial design 736 received at block 1102 (which replaces or enhances block 802 of the method 800) includes information about a design of one or more heating elements, as will be discussed further below. Another difference is that in subroutine block 1104, the simulated environment used for the operational simulation at block 810 is configured to specify an operating temperature at each voxel of the design region 614. In subroutine block 1104, a constant nominal operating temperature is provided to the simulated environment to be used in each of the voxels. As such, the output of subroutine block 1104 is referred to as the nominal optimized design because it is optimized with the assumption that every voxel is at the nominal operating temperature.

At block 1106, an initial heater design based on a design specification is determined. Similar to the initial design 736 based on the design specification and used to specify structural parameters for voxels within the dispersive region 332, the initial heater design may specify include heater parameters that define contents for voxels within the heating design region 1002, which may correspond to the heating layer 910. Heater parameters may include, but are not limited to, one or more heater shape values (e.g., a value specifying a length of a heating element, a value specifying a width of a heating element, etc.); one or more heater size values (e.g., a value specifying a radius of a circular heating element, a value specifying a width of a wire-line heating element, etc.); one or more heater location values (e.g., a value specifying a center location for a heating element; a value or values indicating a path for a wire-line heating element, etc.); or one or more heater timing values (e.g., a value specifying a timing pattern in which power is to be provided to the heating element, etc.).

In some embodiments, the design specification may specify heater parameters for the initial heater design (e.g., a set or sets of voxels to be used as a heating element or heating elements). In some embodiments, the initial heater design may use default heater parameters for the heating element or heating elements. In some embodiments, the design specification may also include values including, but not limited to, a number of heating elements to be included in the heater parameters or a number and/or location of pins for coupling the heating element(s) to a power source. In some embodiments, the design specification may specify desired performance characteristics of the heating element(s), one or more nominal operating temperatures, one or more constraints on power consumption, and/or one or more constraints on temperature effects outside of the design region. In some embodiments, instead of specifying the structural parameters for individual voxels, the design specification and/or the initial heater design may include heater parameters that describe the heating element(s) based on their dimensions (e.g., length and width for rectangular heating elements, radius for circular heating elements or any other suitable parameters for other shapes), based on their location (e.g., vertices of a polygon, a center for a circle, etc.), or any other suitable descriptions of the shapes of the heating element(s).

The method 1100 then proceeds to a for-loop defined between a for-loop start block 1108 and a for-loop end block 826. In the for-loop, performance of the combined heating element(s) and nominal optimized design are simulated at a variety of environmental temperatures. Since the operating temperature is intended to be higher than the expected environmental temperature during operation, using a variety of environmental temperatures will cause the heating element(s) to be operated at varying levels of power to adjust the environmental temperature to the operating temperature.

From the for-loop start block 1108, the method 1100 advances to block 1110, where performance is simulated of the initial heater design in adjusting the environmental temperature to the nominal temperature to determine a temperature gradation. The simulated temperature may be sampled at one or more points within the heating design region and/or the design region associated with the active layer 904 to determine whether the nominal temperature has been reached. Control of the heating element(s) may be provided by controlling a level of voltage applied to the heating element(s), by controlling a power cycle of a constant voltage applied to the heating element(s) (e.g., using pulse-width modulation), or using any other suitable technique.

The simulated temperature associated with each voxel as calculated may be used as the temperature gradation. Since a detailed heat transfer calculation is determined, the temperature gradation encompasses differences in temperature throughout the simulated area. Typically, voxels located farther away from a heating element may be below the nominal temperature, while voxels that overlap a location of a heating element may be above the nominal temperature, even when an average sampled temperature for the simulation as a whole is at the nominal temperature.

Various techniques for simulating resistive heating are known to those of ordinary skill in the art, as are techniques for simulating heat transfer over time using the heat equation, and so precise details of these techniques are not described in further detail herein. In some embodiments, the simulation of the initial heater design may be performed over a time interval that allows the simulated temperatures to reach equilibrium, such that the time component of the heater performance may be ignored for the remainder of the method 1100.

At block 1112, a heater design loss value is determined based on the simulated performance of the initial heater design. In some embodiments, an equilibrium time that represents an amount of time that it takes for the simulated temperatures to reach equilibrium may be measured and used as a component of the heater design loss value, in order to attempt to minimize the amount of time. In some embodiments, a power consumption of the heating element(s) is used as a component of the heater design loss value, in order to attempt to minimize the amount of power consumed. In some embodiments, any other aspect of the heater design that is sought to be optimized may be included as components of the heater design loss value, including but not limited to temperature changes outside of the design region.

At block 1114, an operational simulation 702 is conducted using the nominal optimized design for the dispersive region, given the temperature gradation, to determine a temperature-influenced performance loss value. In contrast to the operational simulation 702 performed at block 810 which used the constant nominal temperature for all of the voxels, the operational simulation performed at block 1114 uses the simulated temperature indicated by the temperature gradation for each voxel, and adjusts the refractive index (and any other temperature-dependent aspects) of the material to be simulated in the voxel based on the simulated temperature. Similar to the performance loss value determined at block 810, the temperature-influenced performance loss value is based on a comparison of the simulated performance to the desired performance.

At block 1116, a temperature loss metric based on the temperature-influenced performance loss value and the heater design loss value is determined. The temperature loss metric may use a loss function that incorporates the temperature-influenced performance loss value and the heater design loss value to compute the temperature loss metric, similar to the way the performance loss and the fabrication loss are combined in the method 800 described above.

The method 1100 then advances to the for-loop end block 1118. If further environmental temperatures remain to be simulated, then the method 1100 returns to the for-loop start block 1108 to process the next environmental temperature. Otherwise, if all of the environmental temperatures have been simulated and temperature loss metrics have been determined for each, then the method 1100 advances from for-loop end block 1118 to a continuation terminal (“terminal A”).

From terminal A (FIG. 11B), the method 1100 advances to block 1120, where an overall loss metric based on the temperature loss metrics at each environmental temperature is determined. The overall loss metric may combine the separate temperature loss metrics in any suitable way that allows gradients to flow back to the structural parameters. As one non-limiting example, a softmax function may be used to select the overall loss metric from the separate temperature loss metrics, but in other embodiments, any other suitable technique may be used to combine the separate temperature loss metrics.

At block 1122, an adjoint simulation 704 is performed to backpropagate the overall loss metric through the simulated environment to determine a structural gradient. As discussed above, backpropagation/adjoint simulation of the overall loss metric indicates a structural gradient that describes changes that should be made in the structures within the design region in order to improve the overall loss metric.

At block 1124, the structural gradient is converted to a heater parameter gradient. The structural gradient implies changes in refractive index that should be made at each voxel in order to improve the overall loss metric. While these changes are used in the method 800 to change the structural parameters between the first material and the second material, here, the changes in refractive index in turn imply changes to the desired operating temperature for the voxel, since the refractive index is dependent upon the operating temperature. The heater parameter gradient may indicate how the structure of the heating element(s) should be changed (as reflected in the heater parameters) in order to better obtain the desired operating temperature for each voxel.

At block 1126, the initial heater design is revised based on the heater parameter gradient. In some embodiments, gradient descent may be used to apply the heater parameter gradient to the heater parameters of the initial heater design.

While blocks 1124-1126 describe a technique in which the structural gradient is translated into a heater parameter gradient directly from the implied changes in refractive index, in some embodiments, other techniques may be used. For example, in some embodiments, the structural gradient may be used to determine the implied changes in refractive index, which then imply changes in the operating temperature. The changed operating temperatures for each voxel may then be combined into a temperature gradation used as an input to conduct an adjoint simulation using the simulator from block 1110 in reverse in order to generate the heater parameter gradient, which may then be used to update the heater parameters.

The method 1100 then proceeds to decision block 1128, where a determination is made regarding whether the method 1100 is done optimizing the heater design, or whether further iterations are desired. In some embodiments, the method 1100 may perform a predetermined number of optimization iterations before being considered done. In some embodiments, the method 1100 may continue until the simulated performance of the optoelectronic device and the heater converge to a stable level or reaches a desired threshold performance.

If further iterations of heater design optimization are desired, then the result of decision block 1128 is NO, and the method 1100 proceeds to a continuation terminal (“terminal B”) to return to the for-loop start block 1108 and conduct further simulations and revisions of the heater design given the nominal optimized design for the dispersive region. Otherwise, if no further iterations are desired, the method 1100 proceeds to block 1130, where the optimized heater design is output for incorporation into the optoelectronic device. In some embodiments, the combined design for the optoelectronic device may then be stored for future use, may be transmitted to a fabrication system to fabricate the optoelectronic device, or may be used for any other purpose.

The method 1100 then proceeds to an end block and terminates.

Though the method 1100 illustrates the optoelectronic device being designed first, and then the heater being designed thereafter, this example should not be seen as limiting. In some embodiments, the heater may be designed first in order to obtain a desired temperature gradation, and the design for the dispersive region may be initially determined using the temperature gradation provided by the designed heater instead of an assumed constant nominal operating temperature. In some embodiments, the design for the dispersive region may be re-optimized using, e.g., the method 800 of FIG. 8, after optimizing the heater design using the method 1100 of FIG. 11A-FIG. 11B. In some embodiments, a technique may alternate several times between optimizing the heater and optimizing the dispersive region.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having computer-executable instructions stored thereon that, in response to execution by one or more processors of a computing system, cause the computing system to perform actions for creating a design for an optoelectronic device, the actions comprising:
determining, by the computing system, an initial heater design that includes one or more heater parameters;
determining, by the computing system, a temperature gradation by simulating performance of the initial heater design in adjusting an environmental temperature to a nominal temperature;
simulating, by the computing system, performance of a nominal optimized design of a dispersive region of the optoelectronic device, given the temperature gradation, to determine a temperature-influenced performance loss value;
determining, by the computing system, a heater parameter gradient based on the temperature-influenced performance loss value; and
revising the heater parameters based at least in part on the heater parameter gradient to create a revised heater design.

2. The non-transitory computer-readable medium of claim 1, wherein the actions further comprise repeating the determining the temperature gradation, simulating performance of the nominal optimized design given the temperature gradation, determining the heater parameter gradient, and revising the heater parameters based at least in part on the heater parameter gradient two or more times.

3. The non-transitory computer-readable medium of claim 1, wherein the heater parameters include at least one of a heater size value, a heater shape value, a heater location value, a heater timing value, and a value indicating a number of heaters.

4. The non-transitory computer-readable medium of claim 1, wherein determining the heater parameter gradient based on the temperature-influenced performance loss value includes:
determining, by the computing system, a loss metric based on the temperature-influenced performance loss value;
backpropagating, by the computing system, the loss metric to determine a structural gradient; and
converting, by the computing system, the structural gradient to the heater parameter gradient.

5. The non-transitory computer-readable medium of claim 1, wherein the temperature gradation is a first temperature gradation, wherein the environmental temperature is a first environmental temperature, wherein the temperature-influenced performance loss value is a first temperature-influenced performance loss value, and wherein the actions further comprise:
determining a second temperature gradation by simulating performance of the initial heater design in adjusting a second environmental temperature to the nominal temperature; and
simulating performance of the nominal optimized design given the second temperature gradation to determine a second temperature-influenced performance loss value.

6. The non-transitory computer-readable medium of claim 5, wherein determining the loss metric based on the temperature-influenced performance loss value includes:
determining a combined loss metric based on the first temperature-influenced performance loss value and the second temperature-influenced performance loss value.

7. The non-transitory computer-readable medium of claim 1, wherein determining the loss metric includes determining a heater design loss value that represents at least one of a power consumption or an equilibrium time.

8. The non-transitory computer-readable medium of claim 1, wherein a material specified by the heater parameters is optically absorptive, and wherein simulating performance of the nominal optimized design given the temperature gradation to determine the temperature-influenced performance loss value includes simulating optical properties of the initial heater design.

9. The non-transitory computer-readable medium of claim 1, further comprising:
transmitting the nominal optimized design and the revised heater design to a fabrication system for fabrication.

10. The non-transitory computer-readable medium of claim 1, wherein the optoelectronic device is a multiplexer or a demultiplexer.

11. A computer-implemented method of creating a design for an optoelectronic device, the method comprising:
determining, by a computing system, an initial heater design that includes one or more heater parameters;
determining, by the computing system, a temperature gradation by simulating performance of the initial heater design in adjusting an environmental temperature to a nominal temperature;
simulating, by the computing system, performance of a nominal optimized design of a dispersive region of the optoelectronic device, given the temperature gradation, to determine a temperature-influenced performance loss value;
determining, by the computing system, a heater parameter gradient based on the temperature-influenced performance loss value; and
revising the heater parameters based at least in part on the heater parameter gradient to create a revised heater design.

12. The computer-implemented method of claim 11, further comprising repeating the determining the temperature gradation, simulating performance of the nominal optimized design given the temperature gradation, determining the heater parameter gradient, and revising the heater parameters based at least in part on the heater parameter gradient two or more times.

13. The computer-implemented method of claim 11, wherein the heater parameters include at least one of a heater size value, a heater shape value, a heater location value, a heater timing value, and a value indicating a number of heaters.

14. The computer-implemented method of claim 11, wherein determining the heater parameter gradient based on the temperature-influenced performance loss value includes:
determining, by the computing system, a loss metric based on the temperature-influenced performance loss value;
backpropagating, by the computing system, the loss metric to determine a structural gradient; and
converting, by the computing system, the structural gradient to the heater parameter gradient.

15. The computer-implemented method of claim 11, wherein the temperature gradation is a first temperature gradation, wherein the environmental temperature is a first environmental temperature, wherein the temperature-influenced performance loss value is a first temperature-influenced performance loss value, and wherein the method further comprises:
determining a second temperature gradation by simulating performance of the initial heater design in adjusting a second environmental temperature to the nominal temperature; and
simulating performance of the nominal optimized design given the second temperature gradation to determine a second temperature-influenced performance loss value.

16. The computer-implemented method of claim 15, wherein determining the loss metric based on the temperature-influenced performance loss value includes:
determining a combined loss metric based on the first temperature-influenced performance loss value and the second temperature-influenced performance loss value.

17. The computer-implemented method of claim 11, wherein determining the loss metric includes determining a heater design loss value that represents at least one of a power consumption or an equilibrium time.

18. The computer-implemented method of claim 11, wherein a material specified by the heater parameters is optically absorptive, and wherein simulating performance of the nominal optimized design given the temperature gradation to determine the temperature-influenced performance loss value includes simulating optical properties of the initial heater design.

19. The computer-implemented method of claim 11, further comprising:
transmitting the nominal optimized design and the revised heater design to a fabrication system for fabrication.

20. The computer-implemented method of claim 11, wherein the optoelectronic device is a multiplexer or a demultiplexer.
